(19) United States
(12) Patent Application Publication
(10) Pub. No.: US 2025/0342445 A1
(43) Pub. Date: Nov. 6, 2025

(54) CATALYST CALENDAR INTERFACE

(71) Applicant: Dropbox, Inc., San Francisco, CA (US)

(72) Inventors: Devin Mancuso, San Francisco, CA (US); Joseph Grillo, San Francisco, CA (US); Bonita Leung, Brooklyn, NY (US); Theo Richardson, Ontario (CA); Rich Chan, San Francisco, CA (US)

(21) Appl. No.: 18/652,320

(22) Filed: May 1, 2024

(51) Int. Cl. G06Q 10/1093; G06F 3/0482

(52) U.S. Cl. CPC G06Q 10/1093; G06F 3/0482

(57) ABSTRACT

The present disclosure relates to systems, non-transitory computer-readable media, and methods for utilizing a large language model to generate computer code executable to generate a series of calendar events for completing a target objective. Furthermore, the disclosed systems provide a catalyst calendar interface which includes a chat window and an integrated calendar window to interface to display the series of calendar events. For instance, the disclosed systems utilize the large language model to generate a task curriculum which includes a set of executable tasks whose completion accomplishes the target objective. Furthermore, the disclosed systems can generate computer code executable by a calendar application to generate the series of calendar events corresponding to the set of executable tasks. The disclosed systems can interact with the chat window to provide the series of calendar events incorporating an integrated view of the calendar application, via the integrated calendar window, using rich calendar content.

### BACKGROUND

Recent years have seen significant improvements in computer hardware and software platforms for generating, modifying, and engaging with productivity tools on digital platforms. For example, the proliferation of computing devices and expansion of network capabilities has led to widespread integration of digital calendars, which make use of graphical user interfaces of computer devices to schedule calendar events. Indeed, digital calendars play an important role in managing time commitments, setting digital reminders, and scheduling recurring calendar events. Despite these advances, however, existing digital calendaring systems often suffer from technological shortcomings that result in a number of deficiencies, particularly in regard to providing accurate, flexible, and efficient scheduling of calendar events aligned with accomplishing target objectives.

As just suggested, current digital calendaring systems are inaccurate. For example, current calendaring systems are often coded or programmed under an event-based paradigm that relies on generating single calendar events (repeating or one-off) that occupy memory and corresponding calendar slots allocated for individual time commitments (e.g., meetings). Indeed, the underlying functionality of existing calendaring systems has remained the same for many years, where systems create calendar events on an as-needed basis upon detecting a meeting or some other calendar event for a specified time interval. Some existing systems, therefore, generate sporadic calendar events with large unoccupied calendar slots in between, providing no indication of event relatedness or continuity. Indeed, such a reactive (or retroactive) approach frequently leads to issues in system accuracy, where an existing calendaring system treats each scheduled calendar event as a standalone data entity, irrespective of other calendar events that may link with (or otherwise be related to) the calendar event based on contextual data (e.g., data that may afford a more global perspective of the state of a user account). Some existing systems, therefore, generate inaccurate or uninformed calendar events disconnected from other, related calendar events.

Relatedly, current calendaring systems are often inflexible. For example, as noted above, current calendaring systems rigidly adhere to an event-based calendar structure where systems generate individual calendar events, each with their own isolated parameters. Such isolated calendar event generating prevents existing systems from adapting calendar events based on interdependencies or other relationships, instead isolating each calendar event based solely on data for the specific calendar event itself.

Furthermore, many existing calendaring systems are navigationally inefficient. For example, many existing calendaring systems utilize a complicated arrangement of multiple user interfaces to generate calendar events across multiple computer applications. For example, current calendaring systems sometimes require a first application to determine parameters for a calendar event (e.g., a messaging application for coordinating between user accounts) and an entirely separate application (e.g., a designated calendaring application) for generating the calendar event using the parameters. Oftentimes, each application in a conventional system provides its own interfaces: one set for determining event parameters in the first application, and another set for generating the calendar event in the calendaring application. Navigating across the multiple interfaces and/or applications of existing systems is inefficient, not only requiring large numbers of client device interactions to access desired data and/or functionality but also consuming excessive computational resources processing the excessive interactions that could otherwise be reduced with a more efficient interface.

These, along with additional problems and issues, exist with regard to existing systems.

### SUMMARY

This disclosure describes one or more embodiments of systems, methods, and non-transitory computer-readable storage media that provide benefits and/or solve one or more of the foregoing and other problems in the art. For instance, the disclosed systems provide a new system for utilizing purpose-built computer code generated by neural networks to interact with a calendar application for restructuring digital calendars based on target objectives. For example, the disclosed systems generate computer code utilizing specially designed prompts for a large language model, where the computer code is executable by a calendar application to allocate calendar time for calendar events. To generate the computer code using the large language model, the disclosed systems can generate a prompt informed by a target objective of a user account, where the target objective defines a high-order goal or objective that the disclosed systems break down into individual executable processes using a context engine. The disclosed systems can thus utilize the large language model to process the prompt (or multiple task-specific prompts) and generate a task curriculum made up of a set of executable tasks whose completion accomplishes the target objective. Furthermore, the disclosed systems integrate with a calendar application to create the calendar events by executing the purpose-built computer code generated using the large language model.

Relatedly, the catalyst calendar system also provides custom graphical user interfaces for generating and managing calendar structures using a combination of a chat window and an integrated calendar window. Through the chat window, the disclosed systems communicate with the calendar application receive user input and provide content to facilitate generation of calendar events based on target objectives. Through the integrated calendar window, the disclosed systems present a detailed representation of calendar events from the calendar application utilizing comprehensive rich calendar content. Thus, the disclosed systems utilize a hybrid interface which unifies or combines: i) elements for interacting with a large language model to decompose a target objective into tasks with ii) elements for interacting directly with, and presenting rich calendar content of, a digital calendar (of an integrated calendaring application) for generating calendar events for the tasks.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment within which a catalyst calendar system can operate in accordance with one or more embodiments;

FIG. 2 illustrates an example overview of a catalyst calendar system generating computer code executable by a calendar application to generate a series of calendar events in accordance with one or more embodiments;

FIG. 3 illustrates an example of utilizing a large language model to generate computer code in accordance with one or more embodiments;

FIGS. 4A-4B illustrate examples of utilizing computer code to interface with a calendar application in accordance with one or more embodiments;

FIG. 5 illustrates a flowchart of a series of acts for providing an event element for display on a catalyst calendar interface in accordance with one or more embodiments;

FIG. 6 illustrates an example overview of utilizing a catalyst calendar interface to provide an event element for display in accordance with one or more embodiments;

FIGS. 7A-7D illustrate example catalyst calendar interfaces for generating, scheduling, and interacting with a series of calendar events in accordance with one or more embodiments;

FIG. 8 illustrates a flowchart of a series of acts for generating a catalyst calendar interface to display a series of calendar events in accordance with one or more embodiments;

FIG. 9 illustrates a block diagram of an exemplary computing device in accordance with one or more embodiments; and

FIG. 10 illustrates a networking environment of a catalyst calendar system in accordance with one or more embodiments.

### DETAILED DESCRIPTION

This disclosure describes embodiments of a catalyst calendar system that provide a novel approach for utilizing purpose-built computer code generated by one or more neural networks to interact with a calendar application for structuring a digital calendar based on a target objective. Rather than generating standalone, isolated calendar events individually (as is done in prior systems), the catalyst calendar system can fundamentally restructure digital calendars based on target objectives which define high level (or high order) goals or objectives made up of, and accomplishable through execution of, multiple constituent tasks. To this end, the catalyst calendar system utilizes a large language model and a context engine together to generate customized computer code executable by a calendar application to generate calendar events corresponding to tasks whose completion accomplish a target objective. In one or more implementations, the catalyst calendar system generates the customized computer code defining a task curriculum which breaks down the target objective into individual processes or tasks. Furthermore, the disclosed systems can integrate with the calendar application to create calendar events for the task curriculum by executing the customized computer code.

### Introduction to Generating Catalyst Calendar Events

As just mentioned, in one or more embodiments, the catalyst calendar system generates a task curriculum utilizing a large language model. To generate the task curriculum, the catalyst calendar system can provide an event generation prompt to a large language model to analyze event parameters and extract tasks to generate a task list (e.g., task curriculum) from the extracted tasks. To elaborate, to initiate a task extraction via the large language model, the catalyst calendar system can generate a prompt that includes natural language terminology requesting the large language model to generate a task curriculum associated with a target objective. In some cases, the catalyst calendar system generates the prompt by converting digital content into a text form and generating terminology requesting the task curriculum generation from the text form of the digital content. In these or other cases, the catalyst calendar system generates multiple prompts by deconstructing (e.g., via a context engine) a target objective into its individual, discrete tasks such that each prompt corresponds to an individual task making up part of the target objective.

In one or more embodiments, the catalyst calendar system can further utilize the large language model and the context engine to generate computer code. As mentioned, the catalyst calendar system can utilize a context engine and large language model to identify target objectives and break them down into discrete executable tasks for the task curriculum (e.g., target objective A is accomplished by performing tasks X, Y, and Z). The catalyst calendar system further utilizes the context engine to provide an event generation prompt (or multiple task-specific event generation prompts) to the large language model, where the prompt is engineered to cause the large language model to generate computer code based on the task curriculum (e.g., executable by a calendar application to generate a series calendar event for tasks of the task curriculum that makes up the target objective). In this way, the catalyst calendar system can generate computer code which is executable by a calendar application to generate calendar events for the tasks in the task curriculum.

Indeed, the catalyst calendar system can generate a series of calendar events associated with one or more target objectives. In particular, the catalyst calendar system can generate calendar events by allocating or associating the executable tasks of the task curriculum to respective calendar events. In some implementations, the catalyst calendar system generates the calendar events based on event parameters and contextual data sources, such as a knowledge graph and/or various connectors that integrate data from external applications or server locations. In some cases, the catalyst calendar system can also use external models to automatically (e.g., without user interaction) execute one or more tasks from the task curriculum.

### Introduction to Catalyst Calendar Interface

Relatedly, the disclosed systems also provide a custom graphical user interface (e.g., catalyst calendar interface) that incorporates a combination of a chat window and an integrated calendar window to streamline interaction with the calendar application. To elaborate, to provide a clear and practical client device experience, the disclosed systems integrate elements of the catalyst calendar interface through interconnected windows. These windows include a chat window and an integrated calendar window. The chat window is designed for communication with the calendar application including user input and commands and an integrated calendar window engineered to present calendar events of the calendar application as comprehensive rich calendar content. For example, the chat window provides content to and accepts input from a user account to generate calendar events based on target objectives. In addition, the integrated calendar window provides a detailed presentation of rich (and interactive) calendar content, including calendar events, descriptions of calendar events, and intelligent suggestions for calendar events.

As mentioned, the catalyst calendar system provides the catalyst calendar interface to interface with a large language model to generate calendar events associated with one or more target objectives. In particular, the catalyst calendar system can provide elements for interacting with a large language model to generate code executable by a calendar application. The catalyst calendar system can utilize the elements to generate and provide prompts to the large language model based on the target objective, as well as information from other integrated digital content items, such as a knowledge graph and various connectors. For example, the catalyst calendar system can interact with the large language model to efficiently generate a calendar structure that includes a series of interrelated tasks for accomplishing a target objective. The catalyst calendar system can also execute tasks and/or perform other calendar operations based on interactions with the catalyst calendar interface.

The flexibility of the catalyst calendar interface extends to efficient task management. In particular, the catalyst calendar interface aids in the execution of tasks by interacting with the large language model to link tasks directly to calendar events (e.g., by generating a series of calendar events corresponding to respective tasks working together toward a target objective). For example, the catalyst calendar system can utilize the elements to update calendar events to align with project timelines (e.g., where a project timeline is expressed as a target objective). In addition, the catalyst calendar system can provide elements designed for in-depth review and analysis of past and upcoming calendar events. Furthermore, the catalyst calendar interface can provide strategic planning support through providing contextual information visually linking calendar events to the accomplishment of one or more target objectives.

Embodiments of the catalyst calendar system can provide many technological advantages and benefits over existing systems and methods. In particular, the catalyst calendar system can improve flexibility relative to existing systems. Specifically, by facilitating free form (e.g., natural language) text interactions for generating calendar events (sometimes generating many events at once for a single text input defining a target objective), the catalyst calendar system can improve system flexibility compared to systems that rigidly require defining specific event parameters for each calendar event. To provide such improved flexibility, the catalyst calendar system utilizes a neural network (e.g., a large language model) to analyze a target objective (or a series of tasks broken out from a target objective by a context engine) and can generate a series of calendar events aligned with accomplishing the target objective. Using the text-based interactions to define a target objective via a catalyst calendar interface along with the underpinnings of a large language model for generating a series of calendar events corresponding to tasks of a target objective, the catalyst calendar system does not generate isolated calendar events (repeating or one-off), nor function as a mere repository of dates and appointments on an as-needed basis. Instead, the catalyst calendar system flexibly adapts an entire calendar structure to achieve the target objective through a series of interrelated calendar events corresponding to tasks broken out from the target objective (within the context of existing commitments and user account preferences).

Similarly, the catalyst calendar system provides additional flexibility compared to options provided by existing calendaring systems. For example, the catalyst calendar system can preemptively identify and resolve conflicts by analyzing existing calendar events and suggesting calendar event modifications and/or alternative time intervals. To illustrate, the catalyst calendar system can provide an overview of a calendar schedule, indicate inconsistencies or where double bookings might occur, and offer calendar event scheduling solutions. Moreover, the catalyst calendar system can analyze the historical scheduling patterns of a user account in tandem with external factors such as public holidays, peak professional periods, and/or personal downtime to ensure that the scheduled calendar events fulfill the target objective while simultaneously satisfying user account preferences and work habits. Overall, the catalyst calendar system can transform how user accounts interact with a calendar application by automating the scheduling process, learning from client device interactions, and proactively assisting in calendar event conflict resolution, thereby bridging the gap between current calendaring systems and target objectives.

Relatedly, in some embodiments, the catalyst calendar system improves system accuracy by treating calendar events as interrelated data entities. In particular, utilizing the context engine and the large language model, the catalyst calendar system generates calendar events as a series of interrelated data objects that together achieve a target objective. More precisely, the catalyst calendar system utilizes a context engine (integrated with a large language model) to break down a target objective into a task curriculum and to generate prompts (e.g., an objective-level prompt or multiple task-specific prompts) for the large language model to generate a series of calendar events for the tasks in the task curriculum. Thus, rather than generating calendar events as independent and/or unrelated data objects in a digital calendar (as done in many prior systems), the catalyst calendar system can restructure an entire digital calendar by generating calendar events in groups or sets that are interrelated as part of achieving a common target objective.

What is more, the catalyst calendar system can improve navigational efficiency over existing calendaring systems through a streamlined and interrelated multi-window client device interface. Indeed, the catalyst calendar system simplifies client device interactions and allows end users to generate a series of calendar events associated with a target objective with minimal client device interaction. By consolidating features into a multi-window interface which includes a chat window and an integrated calendar window, the catalyst calendar system eliminates the need for excessive client device navigation through multiple applications and/or interfaces. Indeed, as opposed to prior systems that require excessive device interactions including case-by-case device interactions for each calendar event, the catalyst calendar system requires far fewer device interactions to control the creation and modification of interdependent calendar events associated with a target objective (e.g., by generating an entire series of calendar events in response to a single text input defining a target objective). Furthermore, the catalyst calendar interface can integrate explanatory information into the catalyst calendar interface including descriptions of how the calendar events impact the accomplishment of one or more target objectives, providing an efficient graphical approach to manage target objectives through calendar events.

As illustrated by the foregoing discussion, the present disclosure utilizes a variety of terms to describe features and benefits of the catalyst calendar system. Additional detail is now provided regarding the meaning of these terms. In particular, as used herein the term “digital content item” (or simply “digital content”) refers to a digital object or a digital file that includes information interpretable by a computing device (e.g., a client device) to present information to a user. A digital content item can include a file or a folder such as a digital text file, a digital image file, a digital audio file, a webpage, a website, a digital video file, a web file, a link, a digital document file, or some other type of file or digital object. A digital content item can have a particular file type or file format, which may differ for different types of digital content items (e.g., digital documents, digital images, digital videos, or digital audio files). In some cases, a digital content item can refer to a remotely stored (e.g., cloud-based) item or a link (e.g., a link or reference to a cloud-based item or a web-based content item) and/or a content clip that indicates (or links/references) a discrete selection or segmented sub-portion of content from a webpage or some other content item or source. A content item can also include application-specific content that is siloed to a particular computer application but is not necessarily accessible via a file system or via a network connection. A digital content item can be editable or otherwise modifiable and can also be sharable from one user account (or client device) to another. In some cases, a digital content item is modifiable by multiple user accounts (or client devices) simultaneously and/or at different times.

As used herein, the term “calendar event” refers to a particular type of content item or data object that marks an allocated time period for a specific requirement, occasion, appointment, task, or milestone within a calendar application. For example, a calendar event can include an entry in a calendar application associated with a discrete block of time (e.g., time interval). A calendar event can include a designated time interval on a calendar associated with a particular purpose, ranging from personal activities to professional obligations such as meetings, conferences, and project deadlines. Among other elements, a calendar event can include details such as the target objective, tasks, event title, start time, end time, location, participant list, objective, agenda, logistics, links, preparatory tasks, and/or other details.

As used herein, the term “target objective” refers to a specific goal or outcome that an individual, user account, group, or system aims to achieve. A target objective can include a goal/outcome to be achieved within a set timeframe, or a milestone used by the catalyst calendar system to schedule and prioritize calendar events. In some cases, a target objective includes or refers to (or corresponds to) a vector representation or an embedding of natural language text that defines a desired goal or outcome. For example, the catalyst calendar system utilizes one or more target objectives to determine criteria for creating and organizing calendar events as well as tracking and evaluating progress in accomplishing goals/outcomes/milestones. To illustrate, a target objective can be as granular as completing a task by a certain deadline or as broad as achieving a long-term strategic goal, such as expanding a business into new markets over the quarter.

As mentioned, the catalyst calendar system can generate a task curriculum utilizing a large language model. As used herein, the term “task” refers to one or more computer processes executable by one or more computer applications and corresponding to an action identified from one or more content items. Accordingly, the term “task curriculum” refers to a curriculum, a set, or a series of tasks that are interrelated and whose accomplishment together achieves a target objective. Example tasks include “email a progress report to the team,” “prepare an agenda,” and “create a list of executable items for the campaign.”

As noted, the catalyst calendar system can generate a task curriculum utilizing a large language model to process an event generation prompt. As used herein the term “event generation prompt” refers to a set of natural language terms arranged to prompt or cause a large language model to generate a calendar event output. In some cases, an event generation prompt includes language defining a request along with accompanying language extracted or generated from a knowledge graph, event parameters, and/or connectors. In particular, the event generation prompt can include a text string that instructs a neural network to generate a series of calendar events associated with accomplishing a target objective within an execution timeframe. In some cases, an event generation prompt corresponds to a target objective and causes a large language model to generate a series of calendar events from the event generation prompt. In other cases, an event generation prompt corresponds to a single task within a task curriculum deconstructed from a target objective and which causes a large language model to generate a single corresponding calendar event.

Along these lines, the term “large language model” refers to a set of one or more machine learning models trained to perform computer tasks to generate or identify computing code and/or data in response to an event generation prompt (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate or identify computing code and/or data based on various contextual data, including information from historical user account behavior.

Relatedly, as used herein, the term “machine learning model” refers to a computer algorithm or a collection of computer algorithms that automatically improve output for a particular task through iterative outputs or predictions based on use of data. For example, a machine learning model can utilize one or more learning techniques to improve model accuracy and/or effectiveness. Example machine learning models include various types of neural networks, decision trees, support vector machines, linear regression models, and Bayesian networks. In some embodiments, the catalyst calendar system utilizes a large language machine learning model in the form of a neural network.

Along these lines, the term “neural network” refers to a machine learning model that can be trained and/or tuned based on inputs to determine calendar events, scores, or approximate unknown functions. For example, a neural network includes a model of interconnected artificial neurons (e.g., organized in layers) that communicate and learn to approximate complex functions and generate outputs (e.g., task lists) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, a diffusion neural network, a generative adversarial neural network, or a large language model.

As used herein, an “calendar application” refers to a computer program, or a set of computer programs, designed to perform specific functions or set of functions related to calendar event scheduling. In particular, calendar applications typically allow for computer communication with other applications or computer systems via an application program interface (i.e., API). As mentioned above, a calendar application may be a native application or a web-based application designed for managing time, setting reminders, and organizing calendar events.

As used herein, “computer code” refers to a set of instructions written in a programming language that a computing device can interpret and execute to perform a specific task. In particular, computer code includes a series of statements and functions that can be utilized by a computer application to execute specific operations. Further, computer code includes statements written in specific syntax and translatable into machine code to be executed by a computing device. Accordingly, the catalyst calendar system generates computer code that corresponds to actions of a calendar application. For instance, the catalyst calendar system generates computer code specific to the a given context derived from digital content and executable by the calendar application to generate and/or modify calendar events.

As used herein the term “event parameters” refers to information associated with calendar events that provides additional context, meaning, or data for generating calendar events. In particular, event parameters can include contextual guidelines that outline the criteria for creating calendar events based on various factors such as a knowledge graph, configuration values, historical data, and/or data from other connected systems. For example, event parameters can include contextual information for determining the time, purpose, and/or duration to create a series of calendar events. For instance, event parameters can specify the optimal timing for an event based on historical attendance patterns, the rationale behind scheduling certain events in relation to overarching goals, or the duration for new events following a trend analysis within the knowledge graph. In addition, event parameters can include predefined constraints associated with how calendar events are created, formatted, and displayed within a graphical interface and/or associated graphical interfaces. For example, event parameters can include formatting specifications for event descriptions, visibility settings for different user roles, or display logic that adjusts the presentation of events in response to client device interactions or system changes.

As used herein the term “catalyst calendar interface” refers to a visual display that allows users to interact with electronic devices, software applications, or systems through graphical elements, such as icons, buttons, windows, windows, and menus. A catalyst calendar interface leverages visual representations to present information, facilitate actions, and provide calendar content to client devices. To illustrate, the catalyst calendar interface includes a graphical interface that incorporates a chat window which can receive event input and an integrated calendar window which can display rich calendar content.

As used herein, the term “rich calendar content” (or “rich content”) refers to a digital media element or a content item that is interpretable by a computing device to present information as more than plain text. In particular, rich calendar content can include a modification to plain text (e.g., text formatting) and/or additional digital media content that is embedded or incorporated within a graphical user interface for presentation or display within the graphical user interface. For example, rich calendar content can include a variety of digital content types, such as hyperlinks, images, videos, infographics, interactive quizzes and polls, interactive graphics, audio files, animations, comments, notes, highlighting, formatting, chatbots, accessibility features, and other visual aids for display within the catalyst calendar interface.

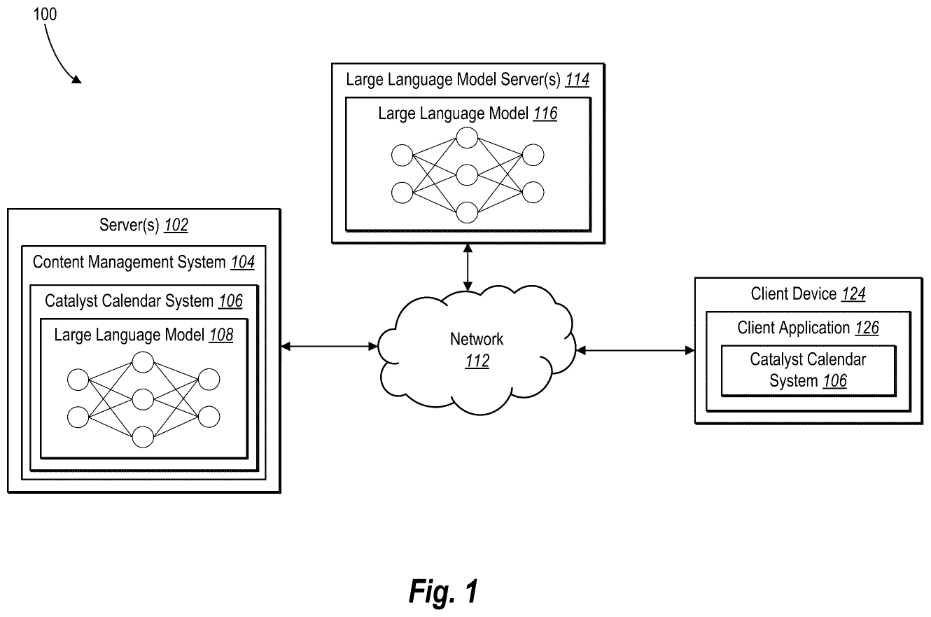

Additional detail regarding the catalyst calendar system will now be provided with reference to the figures. For example, FIG. 1 illustrates a schematic diagram of an exemplary system environment 100 (“environment”) in which a catalyst calendar system 106 can be implemented. An overview of the catalyst calendar system 106 is described in relation to FIG. 1. Thereafter, a more detailed description of the components and the processes of the catalyst calendar system 106 is provided in relation to the subsequent figures.

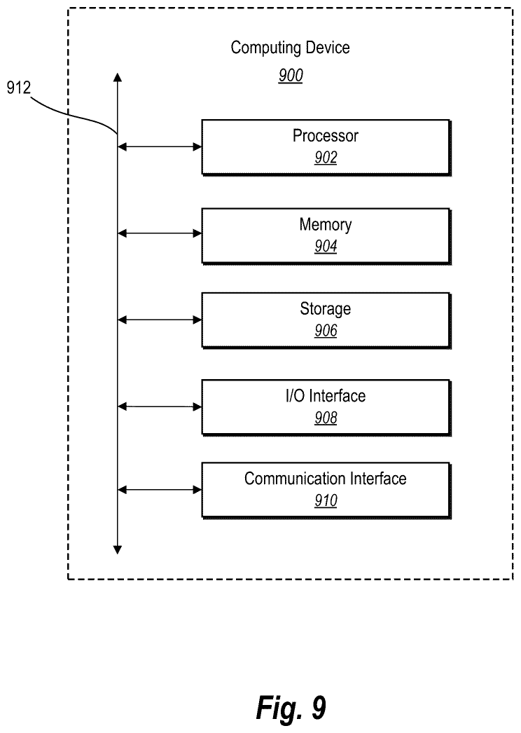

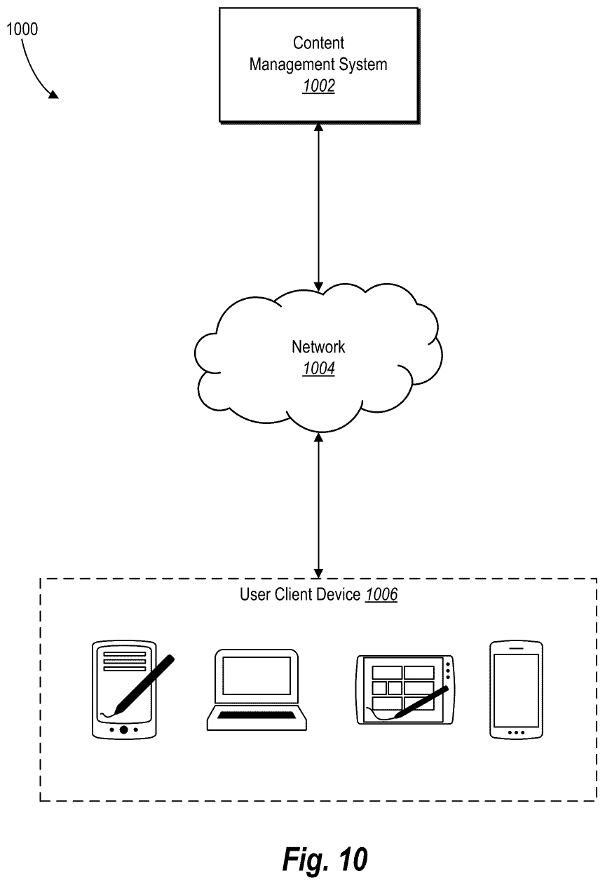

As shown, the environment 100 includes server(s) 102, client device(s) 124, large language model server(s) 114 a network 112. Each of the components of the environment 100 can communicate via the network 112, and the network 112 may be any suitable network over which computing devices can communicate. Example networks are discussed in more detail below in relation to FIGS. 9-10.

As shown, the environment 100 includes large language model server(s) 114 and client device(s) 124. The client device(s) 124 can be one of a variety of computing devices, including a smartphone, a tablet, a smart television, a desktop computer, a laptop computer, a virtual reality device, an augmented reality device, or another computing device as described in relation to FIGS. 9-10. The client device(s) 124 can communicate with the server(s) 102 and or large language model server(s) 114 via the network 112. For example, the client device(s) 124 can receive user input from respective users interacting with the client device(s) 124 (e.g., via the content management system 104) to, for instance, access, modify, add, remove, and/or display calendar events (e.g., via the catalyst calendar system 106). In addition, the catalyst calendar system 106 on the large language model server(s) 114 can receive information relating to various interactions with calendar events and/or graphical interface elements based on the input received by the client device(s) 124 (e.g., to generate calendar events via text instructions in a catalyst calendar interface).

As shown, the client device(s) 124 can include a client application 126. In particular, the client application 126 may be a native application installed on the client device(s) 124 (e.g., a mobile application, a desktop application, etc.), or a cloud-based or web application where all or part of the functionality is performed by the large language model server(s) 114. Based on instructions from the content management system 104, the client device(s) 124 can present or display information, via the client application 126, including a catalyst calendar interface for presenting graphical visualizations of calendar events as well as interface elements for executing and monitoring the status of calendar events.

As illustrated in FIG. 1, the example environment 100 also includes the server(s) 102. The server(s) 102 may generate, track, store, process, receive, and transmit electronic data, such as calendar events, interactions with calendar events, and/or interactions between user accounts or client devices. For example, the server(s) 102 may receive data from the client device(s) 124 in the form of an event generation prompt and/or indications to generate a calendar events, interact with a calendar events, or display/remove calendar events for a graphical system on the client device(s) 124. In addition, the server(s) 102 can transmit data to the client device(s) 124 in the form of a catalyst calendar interface that includes a graphical visualization of calendar events generated from the event generation prompt. Indeed, the server(s) 102 can communicate with the client device(s) 124 to send and/or receive data via the network 112. As shown, the server(s) 102 can also include a large language model 108 that is native to, housed or hosted on, and/or maintained by the content management system 104. In some implementations, the server(s) 102 comprise(s) a distributed server where the large language model server(s) 114 include(s) a number of server devices distributed across the network 112 and located in different physical locations. The server(s) 102 can comprise one or more content servers, application servers, communication servers, web-hosting servers, machine learning servers, and other types of servers.

As shown in FIG. 1, the large language model server(s) 114 can also include the catalyst calendar system 106 as part of a content management system 104. The content management system 104 can communicate with the client device(s) 124 to perform various functions associated with the content management system 104 such as managing user accounts, managing calendar events, managing digital content items, and facilitating user interaction with the calendar events. The content management system 104 can communicate with the large language model server(s) 114 to perform various functions associated with the catalyst calendar system 106 such as identifying and collecting third-party data for the calendar events. Indeed, the content management system 104 can include a network-based cloud storage system to manage, store, and maintain content labels and related data across numerous user accounts.

FIG. 1 further illustrates the large language model server(s) 114. In particular, the large language model server(s) 114 can host or house a large language model 116 (e.g., as an alternative to the server(s) 102 hosting or housing the large language model 108) for access by the catalyst calendar system 106. For example, the large language model server(s) 114 can include a server location hosting the large language model 116 that is external to the catalyst calendar system 106. In some cases, the large language model server(s) 114 is external to the catalyst calendar system 106, but the catalyst calendar system 106 can nevertheless access and utilize the large language model 116 via one or more plugins, APIs, or other network-based access protocols. In some embodiments, the catalyst calendar system 106 and/or the content management system 104 access the large language model server(s) 114 to access and obtain information from third party data sources such as digital content, calendar events, graphical interface data, and other information. In some embodiments, the catalyst calendar system 106 and/or the content management system 104 access the client device(s) 124 to access and obtain information from third party data sources such as digital content, calendar events, graphical interface data, and other information.

Although FIG. 1 depicts the catalyst calendar system 106 located on the server(s) 102, in some implementations, the catalyst calendar system 106 may be implemented by one or more components of the environment (e.g., located entirely or in part). For example, the catalyst calendar system 106 may be implemented by the client device(s) 124, and/or the large language model server(s) 114. For example, the client device(s) 124 can download all or part of the catalyst calendar system 106 for implementation independent of, or together with, the server(s) 102.

In some implementations, though not illustrated in FIG. 1, the environment may have a different arrangement of components and/or may have a different number or set of components altogether. For example, the client device(s) 124 may communicate directly with the catalyst calendar system 106, bypassing the network 112. As another example, the environment may include multiple client devices, each associated with a different user account for managing digital documents.

### Generating Catalyst Calendar Events

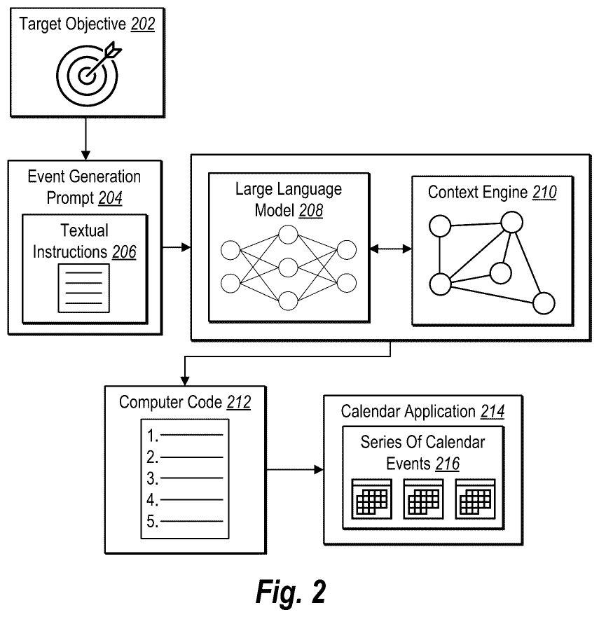

As mentioned above, the catalyst calendar system 106 can generate code executable by a calendar application to generate calendar events that provide information and/or suggest actions based on a target objective. To generate the calendar events, the catalyst calendar system 106 can generate a task curriculum utilizing a large language model to synthesize or extract tasks from digital content based on a target objective. FIG. 2 illustrates an example overview of a catalyst calendar system generating computer code executable by a calendar application to generate a series of calendar events in accordance with one or more embodiments. Additional detail regarding the various parts of FIG. 2 is provided thereafter with reference to subsequent figures.

As illustrated in FIG. 2, in some embodiments, the catalyst calendar system 106 determines a target objective 202. In particular, the catalyst calendar system 106 determines the target objective 202 that reflects a defined outcome or goal that can be achieved within an execution timeframe. For example, the catalyst calendar system 106 determines the target objective 202 as a clear point of focus that informs the strategic generation and organization of calendar events to determine which calendar events are scheduled, the relationship between calendar events, the priority of calendar events, and the allocation of calendar time. As mentioned, the catalyst calendar system 106 determines the target objective 202 by analyzing input that includes event parameters, external connectors, knowledge graphs, specified goals, historical data, and other digital content. To elaborate, a target objective 202 is a natural language expression of a high-order goal, such as completing a specific project, learning a new skill or language, reaching a professional milestone, maintaining a consistent workout schedule, or ensuring regular family time.

As shown, the catalyst calendar system 106 generates an event generation prompt 204 based on the target objective 202. In some cases, the catalyst calendar system 106 generates the event generation prompt 204 based on analyzing terminology of digital input to determine the target objective 202 that corresponds to an execution timeframe. For example, the catalyst calendar system 106 utilizes a context engine 210 to break down the target objective 202 into a task curriculum, where each task in the curriculum corresponds to its own event generation prompt (or where the event generation prompt 204 corresponds to the target objective 202 as a whole). In some cases, the event generation prompt 204 includes language defining a request along with accompanying language extracted or generated from a knowledge graph, event parameters, and/or connectors. In turn, the catalyst calendar system 106 can generate the event generation prompt 204 by generating textual instructions 206 associated with generating tasks associated with the target objective 202. Furthermore, the catalyst calendar system 106 can utilize the event generation prompt 204 to cause the large language model 208 to generate computer code 212 based on the relationships among the extracted tasks.

In some cases, the catalyst calendar system 106 can generate the event generation prompt 204 by generating textual instructions 206 associated with extracting tasks associated with the target objective 202 from digital content items. To illustrate, the catalyst calendar system 106 provides one or more digital content items (or text version of the content items) to the large language model along with a request for generation of a task curriculum (e.g., “analyze the accompanying digital content to generate a list of tasks”). The catalyst calendar system 106 thus generates the event generation prompt 204 in the form of a combination of a natural language request and accompanying (textual representations of) digital content items to provide to a large language model 208.

As shown, the catalyst calendar system 106 provides the event generation prompt 204 to the large language model 208. To elaborate, the catalyst calendar system 106 uses the event generation prompt 204 to cause the large language model 208 to generate computer code 212. In some embodiments, the catalyst calendar system 106 utilizes an external large language model hosted at a third-party server. In some embodiments, the catalyst calendar system 106 utilizes an internal large language model hosted and maintained by the content management system 104. In either case, the catalyst calendar system 106 causes the large language model 208 to process the event generation prompt 201 and generate a task curriculum corresponding to the computer code 212.

As shown, the catalyst calendar system 106 causes the large language model to generate computer code 212 utilizing a context engine 210. As used herein, the context engine 210 includes or refers to a model (e.g., a machine learning model) that works in conjunction with the large language model 208 to break down the event generation prompt 204 into individual prompts and to generate computer code 212 from the prompts. For instance, a context engine 210 determines an order of the event generation prompt 204 (or the target objective 202) and breaks the event generation prompt 204 (or the target objective 202) into a set of first-order prompts. The context engine 210 can further combine outputs generated from each first-order prompt into a context engine output responsive to the initial query. For instance, as described by James Johnson in U.S. patent application Ser. No. 18/482,715, titled CUSTOM INTERPRETER FOR EXECUTING COMPUTER CODE GENERATED BY A LARGE LANGUAGE MODEL, which is hereby incorporated by reference in its entirety, the catalyst calendar system 106 utilizes the context engine 210 to determine how to partition the event generation prompt 204 into subcomponents (or lower-order text queries) to provide to the large language model 208. In certain embodiments, the catalyst calendar system 106 utilizes a context engine as described in U.S. patent application Ser. No. 18/303,496 titled GENERATING MULTI-ORDER TEXT QUERY RESULTS UTILIZING A CONTEXT ORCHESTRATION ENGINE, filed Apr. 28, 2023, and U.S. patent application Ser. No. 18/482,716 titled CUSTOM INTERPRETER FOR EXECUTING COMPUTER CODE GENERATED BY A LARGE LANGUAGE MODEL, filed Oct. 6, 2023, both of which are hereby incorporated by reference in their entireties.

As just mentioned, the catalyst calendar system 106 generates the computer code 212 utilizing the large language model 208 and the context engine 210. In some embodiments, the computer code 212 includes a set of instructions written in a programming language that a computing device (e.g., a calendar application) can interpret and execute to perform a specific task. In particular, the computer code 212 includes a series of statements and functions that execute specific operations. Further, the computer code 212 includes statements written in specific syntax and translatable into machine code to be executed by a computing device. In some cases, the computer code 212 corresponds to digital content items associated with the event generation prompt 204 (e.g., email application, browser history, messaging applications, calendar events, file history, file content, etc.). For instance, the large language model 208 generates the computer code 212 specific to each of the contextual data sources and executable to generate a series of calendar events 216.

As further shown, the catalyst calendar system 106 provides the computer code 212 to the calendar application 214. In some implementations the computer code 212 is represented by pseudocode designed to perform operations through the use a programming interface (API) call to interface with a calendar application. For example, the catalyst calendar system 106 can utilize the computer code 212 to extract data from a calendar application and use the data from the calendar application (e.g., for further calendar event scheduling). As an additional example, the catalyst calendar system 106 can utilize the computer code 212 to interact with the calendar application to generate a series of calendar events 216 whose completion accomplishes the target objective 202. To illustrate, the catalyst calendar system 106 can utilize the computer code 212 to schedule new calendar events, update or modify existing calendar events, or even delete outdated or completed calendar events. In some cases, the catalyst calendar system 106 can integrate with the calendar application 214 to create calendar events for the task curriculum by executing the customized computer code utilizing one or more executors (e.g., calendar application executors) integrated by an interpreter as described in described by Devin Mancuso in U.S. patent application Ser. No. 18/435,023, titled CATALYST APPLICATION FOR EXTRACTING AND EXECUTING TASKS, which is hereby incorporated by reference in its entirety.

In some cases, the catalyst calendar system 106 suspends the generation and/or execution of the computer code 212 (e.g., after generating a portion of the computer code 212 for a first set of calendar events, but before generating additional code for a second set of calendar events). For example, the catalyst calendar system 106 may determine that the large language model 208 or context engine 210 require additional information associated with the target objective 202 to generate the computer code 212. To illustrate, the catalyst calendar system 106 may determine that generating the computer code 212 to accomplish the target objective 202 requires additional information from digital content items, regarding associated user accounts, or from associated applications. In some cases, the catalyst calendar system 106 suspends and/or interrupts the generation of the computer code 212 and prompts the client device to provide the additional information associated with accomplishing the target objective 202. As a result of receiving the additional information (or an indication the additional information is not available), the catalyst calendar system 106 can resume operation and generate the computer code 212 based on the additional information (or lack of additional information).

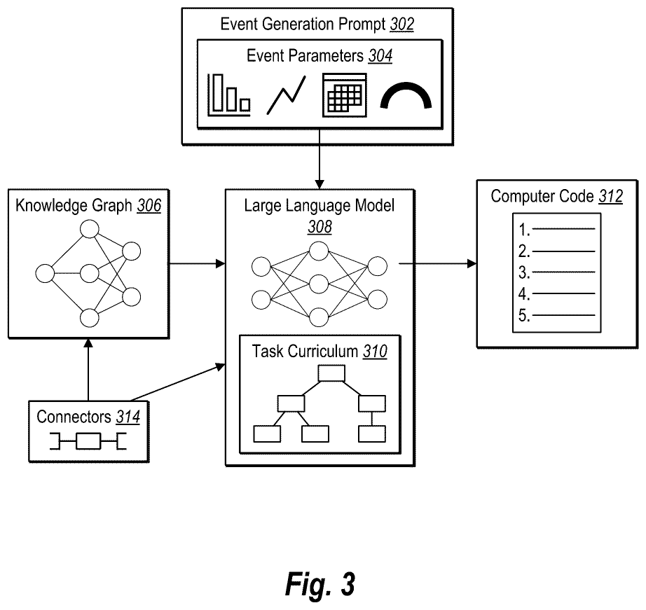

As mentioned above, in certain embodiments, the catalyst calendar system 106 utilizes a large language model to generate computer code. In particular, the catalyst calendar system 106 utilizes a large language model informed by event parameters and contextual data sources, such as a knowledge graph and/or various connectors to generate computer code executable by a calendar application. FIG. 3 illustrates an example of utilizing a large language model to generate computer code in accordance with one or more embodiments.

As shown, the catalyst calendar system 106 generates an event generation prompt 302 to provide to a large language model 308. To elaborate, the catalyst calendar system 106 generates the event generation prompt 302 utilizing a context engine to break down or deconstruct a target objective into a set of tasks (e.g., a task curriculum) whose execution satisfies the target objective. The context engine further generates the event generation prompt 302 as a large language model prompt engineered for generating a calendar event for a task within the task curriculum. In some cases, the event generation prompt 302 includes language defining a request along with accompanying language extracted or generated from a knowledge graph 306 and/or connectors 314. Moreover, the catalyst calendar system 106 generates the event generation prompt 302 informed by event parameters 304 including target objectives, configuration values, and historical data, and other configuration values. For example, the catalyst calendar system 106 can generate the event generation prompt 302 which includes a natural language request for generating the computer code 312 from digital content items. To illustrate, the catalyst calendar system 106 generates or utilizes the event generation prompt 302 in the form of a pre-generated natural language query, such as “generate computer code associated with a task curriculum for the accompanying data.”

In some cases, the catalyst calendar system 106 determines event parameters 304 that provide additional context, meaning, or data for generating calendar events. For example, the catalyst calendar system 106 determines event parameters 304 from one or more target objectives associated with achieving specific, defined goals. In particular, the event parameters 304 include time constraints (e.g., deadlines), associated user accounts involved in a target objective, designated data sources storing content items accessed for achieving a target objective, and/or other parameters defined in a target objective. In some cases, the event parameters 304 include business targets, such as a sales quota or a goal of expanding to a new market. In some cases, the event parameters 304 include teambuilding objectives, such as completing networking goals, or implementing team-building exercises. In some cases, the event parameters 304 include learning goals, such as a target language to learn or a target skill to learn.

In addition, the catalyst calendar system 106 determines event parameters 304 that include configuration values associated with integrating calendar events within a calendar application. For example, event parameters 304 include configuration values associated with determining allowable time blocks for creating calendar events, such as working hours, business hours, time zone restrictions, and/or account preferences. In some cases, event parameters 304 include configuration values associated with duration settings for different calendar events (e.g., 30 minutes for check-ins, 1 hour for team meetings). In some cases, event parameters 304 include configuration values for automatic calendar event acceptance and conflict resolution protocols for calendar events. In addition, the calendar event parameters can include event type (e.g., determining parameters for visibility, reminders, duration).

Furthermore, the catalyst calendar system 106 determines event parameters 304 to coordinate between calendar events. For example, event parameters 304 include configuration values for task priority, such as high priority (e.g., critical deadlines, time-sensitive tasks), medium priority (e.g., regular team updates, client check-ins), and low priority (e.g., brainstorming session, non-urgent administration). Relatedly, event parameters 304 include configuration values for deadline proximity, event flexibility, and urgency. Furthermore, the event parameters 304 include configuration values such as participant availability (e.g., checking against user account calendar events in other calendars) and location suitability (e.g., evaluating calendar events against space, privacy, amenities).

In addition, the catalyst calendar system 106 determines event parameters 304 that include historical data such as information from past calendar events and user account interactions. In particular, the catalyst calendar system 106 can utilize historical data to determine patterns and determine user account preferences. For example, event parameters 304 include historical data associated with successful completion of tasks or projects associated with past calendar events. In some cases, event parameters 304 include historical data associated with the most common types of calendar events (e.g., client meetings, internal reviews) and common participants involved in meetings. In some cases, event parameters 304 include historical data associated with cancellation rates for calendar events scheduled at certain times of day or days of the week.

In addition to the event parameters 304, as also shown in FIG. 3, the catalyst calendar system 106 can utilize other contextual data to inform the process of generating the computer code 312. For example, the catalyst calendar system 106 utilizes a knowledge graph 306 to generate the task curriculum 310 based on connections between user accounts, relationships among the set of executable tasks, event parameters 304, application content (e.g., through connectors 314), and/or digital content items. In some cases, the catalyst calendar system 106 generates a prompt modifier for the event generation prompt 302 according to data indicated by the knowledge graph 306. In some cases, the catalyst calendar system 106 generates the computer code 312 by providing the prompt modifier with the event generation prompt 302.

To illustrate, the catalyst calendar system 106 utilizes the knowledge graph 306 to provide contextual data to the large language model 308 to generate the computer code 312. For example, if digital content items are focused on a common project, dubbed “Common Project,” the catalyst calendar system 106 can utilize the knowledge graph 306 to analyze the recurrence of this topic across multiple digital content items associated with a user account. Through the knowledge graph 306, the catalyst calendar system 106 may identify user accounts in a chat mentioned as collaborators within a team or group in relation to the “Common Project” (e.g., utilizing connectors 314). With this insight, the catalyst calendar system 106 utilizes the knowledge graph 306 to generate a task curriculum 310 that is not only relevant to the group identified but also centered around the specific subject of “Common Project.”

To elaborate, the catalyst calendar system 106 can generate and/or analyzes nodes and edges within the knowledge graph 306, where nodes represent tasks, target objectives, user accounts, and/or content items and where edges represent relationships therebetween. For instance, the catalyst calendar system 106 can determine semantic topics, user account goals, related user accounts, scheduled execution times, geographic locations, and/or other data for various tasks and projects to define each node in the knowledge graph 306. The catalyst calendar system 106 can thus generate and/or analyze edges between the nodes (e.g., the task nodes and target objective nodes) to indicate their relationships to one another based on the various data. In some cases, the catalyst calendar system 106 can group tasks within a task curriculum based on determining that their nodes are within a threshold distance (or a threshold degree of separation or number of edges) apart within the knowledge graph 306 (and/or within a threshold distance/separation from a target objective node). In some embodiments, the catalyst calendar system 106 utilizes a knowledge graph as generated and implemented in U.S. patent application Ser. No. 18/482,715 (incorporated above).

Relatedly, as part of generating the task curriculum 310, the catalyst calendar system 106 can prioritize or order tasks based on relationships among a set of executable tasks. Along these lines, the catalyst calendar system 106 can generate the task curriculum 310 for a particular target objective by ordering tasks from content items more closely related to (e.g., more frequently accessed related to) the target objective above tasks from less related content items. Furthermore, the catalyst calendar system 106 can order tasks of the task curriculum 310 based a priority of the target objective (e.g., between one or more of the task curriculum 310). For example, the catalyst calendar system 106 can determine (e.g., based on the knowledge graph 306) that the target objective associated with a first task is associated with a high priority within an organizational structure whereas another target objective associated with a second task is not associated with a high priority. Thus, the catalyst calendar system 106 can prioritize, or order, tasks from the target objective above tasks from the other target objective.

As also illustrated in FIG. 3, the catalyst calendar system 106 can utilize connectors 314 to inform the large language model 308 for generating the computer code 312. For example, the catalyst calendar system 106 can access connectors 314 that integrate application data from one or more external computer applications. In some embodiments, the connectors 314 include computer code segments, applications, or programs that retrieve or extract features or metrics that define information from user-account-facing applications, such as digital calendars, video call applications, email applications, text messaging applications, and other applications. To illustrate, utilizing connectors 314 for a video call application, the catalyst calendar system 106 can collect data on call frequency and participant lists, which can indicate collaboration patterns. As another example, by utilizing connectors 314 for an email application, the catalyst calendar system 106 can determine insights into project progress through keyword analysis of message content. As another example, the catalyst calendar system 106 can utilize connectors 314 for text messaging applications to reveal urgent tasks through a frequency and/or a tone of text messages. The catalyst calendar system 106 can thus generate the event generation prompt 302 based on (or in association with) the background event parameters.

Indeed, the catalyst calendar system 106 can utilize the connectors 314 to integrate with the calendar application. For example, the catalyst calendar system 106 can utilize the connectors 314 to bring in context data from stored content items associated with a user account (or multiple collaborating user accounts), from calendar applications (of multiple collaborating user accounts), from web-based data integrated from a browser application, from communication data integrated from one or more messaging or email applications, and/or from other integrated applications. In some cases, the connectors 314 integrate with a calendar application for calendar application context, such as usage metrics (e.g., frequency and recency of access) and/or calendar information for upcoming meetings or project deadlines. To illustrate, the catalyst calendar system 106 can generate the task curriculum 310 by ordering tasks according to deadlines indicated by analyzing data from the calendar application to accomplish the tasks on within an execution timeframe. In some cases, catalyst calendar system 106 can generate the task curriculum 310 by ordering tasks according to available time blocks and to accommodate existing calendar events as designated by the calendar application through the connectors 314. In some embodiments, the catalyst calendar system 106 utilizes connectors as generated and implemented in U.S. patent application Ser. No. 18/482,715 (incorporated above).

Furthermore, the catalyst calendar system 106 can cause the large language model 308 to generate tasks that are associated with a goal-oriented task curriculum. For example, the large language model 308 determines tasks that contribute to a target objective (e.g., an overarching project) and combines the tasks together into a task curriculum 310. In addition, the large language model 308 can identify new tasks that correspond to a previously generated task curriculum (or its corresponding target objective) and can integrate the new tasks into the task curriculum 310. If no previously generated task curriculum exists for an identified target objective, the catalyst calendar system 106 can generate the task curriculum 310 for the newly identified target objective. Furthermore, the large language model 208 can identify existing tasks that correspond to one or more task curriculums (or corresponding target objectives) that are no longer relevant (e.g., do not help accomplish the target objectives or have been replaced by new tasks) and can remove the existing tasks from the corresponding task curriculum.

As shown, the catalyst calendar system 106 utilizes the large language model 308 to generate the computer code 312. For example, the catalyst calendar system 106 generates computer code 312 which can include machine code or another intermediate representation of code executable by a calendar application (e.g., where the code may be customized depending on the target calendar application identified for a user account). To illustrate, the large language model 308 analyzes the event generation prompt 302, event parameters 304, knowledge graph 306, connectors 314, and/or additional digital content items to identify action items (e.g., calls to action) and other content that corresponds to target objectives (and tasks) within the digital content. In some cases, the large language model 308 summarizes or synthesizes the event generation prompt 302, event parameters 304, knowledge graph 306, connectors 314, and/or additional digital content items to generate the task curriculum 310 (e.g., omitting portions of the digital content that do not include calls to action and summarizing those portions that include calls to action as tasks). Further, the large language model 308 generates the computer code 312 based on the identified action items.

As mentioned, in certain cases, the catalyst calendar system 106 suspends the generation of the computer code 312. As an example, based on information associated with completing the target objective, the catalyst calendar system 106 determines that the large language model 308 requires additional information to generate the computer code 312. Further, the catalyst calendar system 106 determines that generating the computer code 312 requires additional information from the event generation prompt 302, knowledge graph 306, and/or connectors 314. In some cases, the catalyst calendar system 106 suspends and/or interrupts the generation of the computer code 312 and prompts the client device to provide the additional information. The catalyst calendar system 106 resumes operation and generates the computer code 312 utilizing the additional information (or based on the lack of additional information).

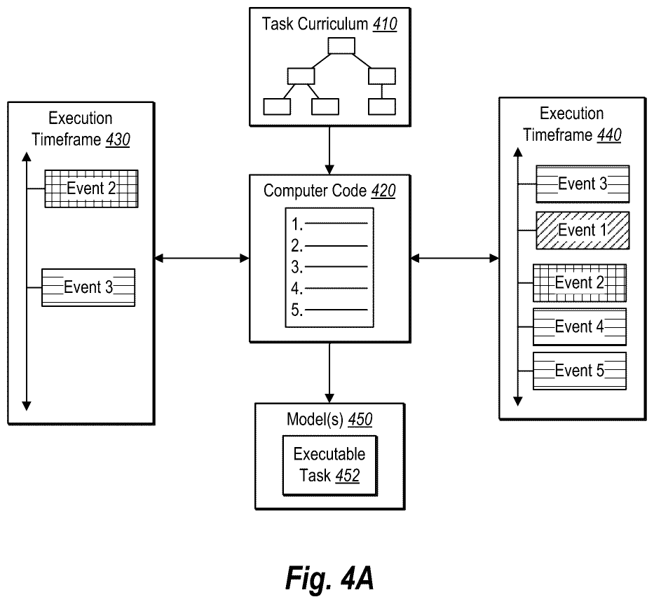

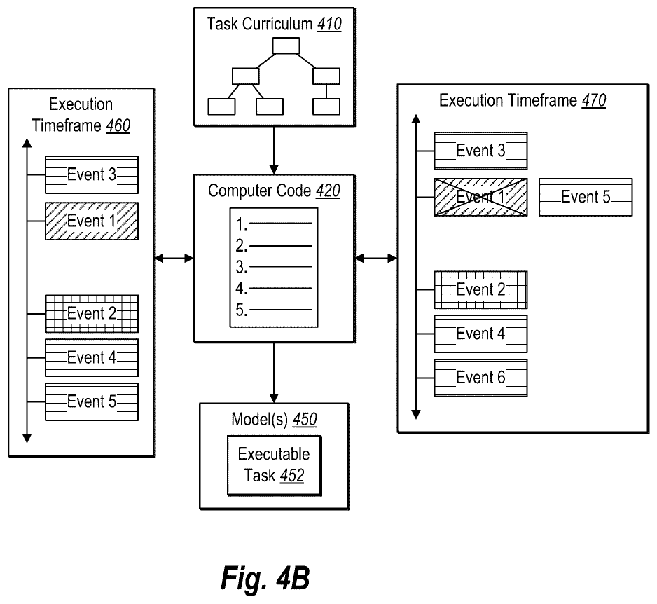

As noted above, in certain described embodiments, the catalyst calendar system 106 generates a task curriculum and computer code to integrate with a calendar application. In particular, the catalyst calendar system 106 generates computer code for generating calendar events corresponding to a task curriculum to achieve a target objective. FIGS. 4A-4B illustrate examples of utilizing computer code to interface with a calendar application in accordance with one or more embodiments.

As mentioned above, and shown in FIG. 4A, the catalyst calendar system 106 generates a task curriculum 410 of tasks associated with accomplishing a target objective. The catalyst calendar system 106 further generates computer code 420 to interface with a calendar application and generate, schedule, modify, add, remove, update, and interact with calendar events for the task curriculum 410. As described above, the catalyst calendar system 106 can instruct a large language model to generate executable computer code in the form of function calls (e.g., for operating systems and/or computer applications) to interface with a calendar application. Indeed, the catalyst calendar system 106 can perform direct application manipulation for task execution by using a large language model to generate function calls for automating actions integrated with the calendar application.

For example, the catalyst calendar system 106 can interface with the calendar application to coordinate calendar events utilizing the computer code 420. As mentioned, the catalyst calendar system 106 interfaces with the calendar application to determine calendar event data which can include event duration, calendar event priority, calendar event participants, associated calendar events, associated applications, and associated resources. To illustrate, the catalyst calendar system 106 can interface with the calendar application to receive an indication of scheduled calendar events that are allocated to time intervals within an execution timeframe 430. Further, the catalyst calendar system 106 can interface with the calendar application to provide computer code 420 to update the scheduled calendar events allocated to time intervals within an execution timeframe 440. To illustrate, the catalyst calendar system 106 interfaces with the calendar application to assess scheduled calendar events including the calendar events of “Event 2” and “Event 3” associated with an execution timeframe 430. In addition, the catalyst calendar system 106 interfaces with the calendar application to provide computer code 420 to update the scheduled calendar events including the calendar events of “Event 1,” “Event 2,” “Event 3,” “Event 4,” and “Event 5” associated with an execution timeframe 440.

In some cases, the catalyst calendar system 106 can generate the computer code 420 to interface with the calendar application to allocate time intervals (e.g., periods of time) within an execution timeframe 440 for calendar events associated with a target objective. For example, the catalyst calendar system 106 determines an execution timeframe 440 for completing the target objective and determines a series of event durations for completing the each of the series of calendar events (or the corresponding tasks in the task curriculum) within the execution timeframe 440. For example, the catalyst calendar system 106 can provide the computer code 420 to interface with the calendar application to generate a series of calendar events (e.g., “Event 3,” “Event 4,” and “Event 5”) within the execution timeframe 440 based on the target objective (e.g., “Target Objective A”). Furthermore, the catalyst calendar system 106 can provide the computer code 420 to interface with the calendar application to set an interval of time allocated to the target objective and/or the series of calendar events.

Relatedly, the catalyst calendar system 106 can generate the computer code 420 to interface with the calendar application to add calendar events associated with existing target objectives. For example, as indicated by the hatching patterns of the illustrated events, the catalyst calendar system 106 can determine that “Event 3” (within execution timeframe 430) is associated with accomplishing “Target Objective A.” Further, the catalyst calendar system 106 can determine that accomplishing “Target Objective A” requires additional calendar events of “Event 4” and “Event 5.” The catalyst calendar system 106 can provide the computer code 420 to interface with the calendar application to add the additional calendar events of “Event 4” and “Event 5.” In addition, the catalyst calendar system 106 can provide the computer code 420 to interface with the calendar application to associate calendar events that accomplish a target objective with each other (as shown by the similar shading for “Event 3,” “Event 4,” and “Event 5” in FIG. 4A). As shown, the catalyst calendar system 106 can provide the computer code 420 to interface with the calendar application to order the set of executable tasks based on the relationships among the set of executable tasks.

Furthermore, the catalyst calendar system 106 can organize and schedule calendar events within the execution timeframe 440 according to urgency, importance, or relevance of the related tasks to accomplishing one or more target objectives. Indeed, the catalyst calendar system 106 determines a priority for the set of executable tasks (and set of calendar events) based on a relationship between the set of executable tasks and scheduled calendar events. In some cases, the catalyst calendar system 106 can assess the priority of tasks in the task curriculum 410 and provide the computer code 420 to interface with the calendar application to assign associated calendar events to time intervals based on the priority assessment.

To illustrate, the catalyst calendar system 106 determines the “Target Objective A” has a higher priority than “Target Objective B” or “Target Objective C” (each corresponding to a different hatching pattern of events in FIG. 4A). As a result, the catalyst calendar system 106 provides the computer code 420 to interface with the calendar application to schedule calendar events with high-priority tasks from “Target Objective A” (e.g., “Event 3,” “Event 4,” and Event 5”) to priority time intervals within the execution timeframe 440, while lower-priority tasks from “Target Objective B” (e.g., “Event 1”) or “Target Objective C” (e.g., “Event 2”) are fitted into time intervals around them. Notably, although “Event 1” and “Event 2” are associated with lower-priority tasks, the catalyst calendar system 106 provides the computer code 420 to interface with the calendar application to schedule calendar events “Event 1” during a time interval to aid in accomplishing associated “Target Objective B” and “Event 2” during a time interval to aid in accomplishing associated “Target Objective C.”

In some cases, the catalyst calendar system 106 provides the computer code 420 to interface with the calendar application to order (or re-order) the calendar events based on accomplishing target objectives, project phases, dependencies among tasks, and/or chronological sequences. For example, the catalyst calendar system 106 provides the computer code 420 to interface with the calendar application to schedule calendar events “Event 3,” “Event 4,” and “Event 5” chronologically in time intervals that are engineered to aid in accomplishing “Target Objective A” within the execution timeframe 440. To illustrate, based on analyzing the tasks in the task curriculum 410, the catalyst calendar system 106 provides the computer code 420 to interface with the calendar application to chronologically schedule “Event 3” with an earlier time interval than “Event 4,” and “Event 4” with an earlier time interval than “Event 5.”

As further illustrated in FIG. 4A, in some cases, the catalyst calendar system 106 performs an executable task 452 by interfacing with model(s) 450. In some embodiments, the catalyst calendar system 106 determines the executable task 452 based on the task curriculum 410. For instance, the catalyst calendar system 106 interacts with the calendar application to determine the executable task 452. In some cases, the catalyst calendar system 106 receives an indication of user interaction associated with the calendar application to execute an executable task 452 associated with a calendar event. In some embodiments, to execute the executable task 452, the catalyst calendar system 106 can utilize a large language model to automatically generate code defining processes or functions processable by native computer applications integrated with the catalyst calendar system 106.

To elaborate, the catalyst calendar system 106 executes the executable task 452 task by utilizing or communicating with one or more model(s) 450, such as models internal to the catalyst calendar system 106 and/or models external to the catalyst calendar system 106. In some cases, executing an executable task 452 requires one of the model(s) 450. In other cases, executing the executable task 452 requires multiple of the model(s) 450. Either way, the catalyst calendar system 106 identifies the model(s) 450 capable of executing the executable task 452, provides execution data to the model(s) 450, and orchestrates execution of the executable task 452 using the model(s) 450. In some cases, the catalyst calendar system 106 receives a request to execute multiple tasks of the executable task 452 in order (e.g., all tasks in a task curriculum), and the catalyst calendar system 106 processes each executable task 452 in turn. In some embodiments, the catalyst calendar system 106 generates the computer code for utilizing various of the model(s) 450 (including passing data between model(s) 450) using a large language model.

Furthermore, the catalyst calendar system 106 can determine additional execution data for the executable task 452 by querying the client device. To elaborate, the catalyst calendar system 106 utilizes a large language model to generate a query that prompts a response from a client device to provide additional execution data. Indeed, the catalyst calendar system 106 generates a follow-up query to gather additional information for executing the executable task 452. As an example, the catalyst calendar system 106 generates a follow-up query of “I need some more information to generate the agenda for the upcoming team meeting. Which projects will be discussed?” In this example, the catalyst calendar system 106 can access the task curriculum 410 and/or the calendar application to determine a recommended agenda (e.g., based on tasks and/or calendar events) or suggest adjustments to an existing agenda. Further, the catalyst calendar system 106 can receive a response from the client device, to identify the additional execution data.

To execute the executable task 452, the catalyst calendar system 106 can utilize a large language model to generate a call to an application programming interface (API). For example, the catalyst calendar system 106 can provide computer code 420 for generating an API call for the model(s) 450 identified for executing the executable task 452. In some cases, the catalyst calendar system 106 instructs the large language model to generate an API call to generate a particular digital content item, modify an application, generate and send a digital communication, or perform some other task via the model(s) 450. For example, the catalyst calendar system 106 can provide a prompt for generating an API call for the model(s) 450 identified for executing the task. Specifically, the catalyst calendar system 106 can utilize a context engine (as described in U.S. patent application Ser. No. 18/435,023) to generate API calls for executing tasks using internal and/or external models or applications.

In some cases, the catalyst calendar system 106 generates collaborative calendar events. For example, the catalyst calendar system 106 can determine a calendar event includes a collaboration between one or more user accounts. The catalyst calendar system 106 can utilize the large language model to determine a collaborative time interval for scheduling the calendar event for multiple user accounts (e.g., a first user account and a second user account). For example, the catalyst calendar system 106 determines, based on communicating with the calendar application, an available collaborative time interval for scheduling the calendar event comprising a time interval that is available across multiple user accounts (e.g., the first user account and the second user account). Furthermore, the catalyst calendar system 106 generates and provides the computer code 420 to interface with the calendar application to generate a first instance of the calendar event within the execution timeframe 440 during the available collaborative time interval for the first user account. In addition, the catalyst calendar system 106 generates and provides the computer code 420 to interface with the calendar application to request the generation of a second instance of the calendar event within the execution timeframe 440 during the available collaborative time interval for the second user account.

FIG. 4B provides additional examples of the catalyst calendar system 106 generating computer code 420 to interface with a calendar application and generate, schedule, modify, add, remove, update, and otherwise interact with calendar events. Similar to FIG. 4A, the catalyst calendar system 106 can interface with the calendar application to coordinate calendar events utilizing the computer code 420. In some embodiments, the catalyst calendar system 106 can interface with the calendar application to receive an indication of scheduled calendar events that are allocated to time intervals within an execution timeframe 460. Further, the catalyst calendar system 106 can interface with the calendar application to provide computer code 420 to update the scheduled calendar events allocated to time intervals within an execution timeframe 470. To illustrate, the catalyst calendar system 106 interfaces with the calendar application to assess scheduled calendar events including the calendar events of “Event 1,” “Event 2,” “Event 3,” “Event 4,” and “Event 5” associated with an execution timeframe 460. In addition, the catalyst calendar system 106 interfaces with the calendar application to provide computer code 420 to update the scheduled calendar events including the calendar events of “Event 2,” “Event 3,” “Event 4,” “Event 5,” and “Event 6” associated with an execution timeframe 470.

As shown, in one or more embodiments, the catalyst calendar system 106 can modify and schedule calendar events associated with one or more target objectives. For example, the catalyst calendar system 106 can rearrange, delete, and/or modify calendar events to accommodate or achieve the target objectives. To elaborate, the catalyst calendar system 106 can identify inefficiencies in the allocation of calendar events within the execution timeframe 460. In some cases, the catalyst calendar system 106 can identify inefficiencies such as overlapping meetings, insufficient time allocated to target objectives, incorrect ordering of calendar events, calendar events scheduled during non-working hours, or insufficient buffer time between appointments. Further, the catalyst calendar system 106 provides the computer code 420 to interface with the calendar application to modify the schedule of calendar events within the execution timeframe 460 to resolve conflicts and align calendar events to achieve the target objectives. In some embodiments, the catalyst calendar system 106 updates the computer code 420 based on receiving client device approval of proposed changes to calendar events represented in the execution timeframe 460.

To illustrate, the catalyst calendar system 106 can provide the computer code 420 to interface with the calendar application to modify the calendar events represented in the execution timeframe 470. For example, the catalyst calendar system 106 can identify available time intervals within the execution timeframe 470 based on a priority of the target objective. In some cases, the catalyst calendar system 106 can reschedule less critical calendar events represented in the execution timeframe 460 to another day or time, shorten calendar events that can be condensed, or remove unnecessary calendar events. In some cases, the catalyst calendar system 106 continues to monitor the calendar application for any new changes or additional calendar events represented within the execution timeframe 460 and iteratively provides computer code 420 to adjust the calendar events as new information becomes available (e.g., changes in scheduled events and/or target objectives). In some cases, the catalyst calendar system 106 can determine an incomplete status of the target objective based on a status of the set of executable tasks and generate the computer code 420 to interface with the calendar application to generate an additional calendar event for completing the task curriculum 410 (e.g., “Event 6”).

In some cases, the catalyst calendar system 106 provides the computer code 420 to interface with the calendar application to adjust the calendar events based on one or more target objectives. For example, the catalyst calendar system 106 provides the computer code 420 to interface with the calendar application to reorder the calendar events “Event 3,” “Event 5,” “Event 4,” and “Event 6” for accomplishing “Target Objective A” chronologically within the execution timeframe 440. As also shown, in this example, the catalyst calendar system 106 analyzes the existing calendar events and determines changes associated with accomplishing “Target Objective A” (e.g., scheduled times, durations, locations, participants, and priorities) and provides the computer code 420 to reorder the calendar event “Event 5” to a new time interval. In some cases, the catalyst calendar system 106 provides the computer code 420 to modify, in response to a change in the series of calendar events, the calendar event “Event 5.” As also shown, the catalyst calendar system 106 determines a missing calendar event (and/or executable task) to accomplish the target objective within the execution timeframe 470 and provides the computer code 420 to add a new calendar event “Event 6” associated with accomplishing “Target Objective A.”

As also shown in FIG. 4B, the catalyst calendar system 106 can generate computer code 420 to remove and/or reschedule calendar events. For example, the catalyst calendar system 106 can evaluate the importance and flexibility of the calendar events represented in the execution timeframe 460 to determine one or more calendar events to remove and/or reschedule based on the task curriculum 410. As shown, the catalyst calendar system 106 provides the computer code 420 to interface with the calendar application to remove the calendar event “Event 1.” As further shown, the catalyst calendar system 106 can provide the computer code 420 to interface with the calendar application to replace the calendar event “Event 1” with calendar “Event 5.” For example, the catalyst calendar system 106 can determine that the calendar event “Event 5” associated with the “Target Objective A” has a higher priority than the calendar event “Event 1” and replace calendar event “Event 5” with calendar event “Event 1.” For example, the catalyst calendar system 106 can determine that replacing the calendar event “Event 1” with calendar event “Event 5” helps to accomplish the “Target Objective A” based on the task curriculum 410. In some cases, the catalyst calendar system 106 can determine to reschedule the calendar event “Event 1” to another time interval.

As also shown, the catalyst calendar system 106 can generate computer code 420 to adjust calendar events based on historical calendar data. For example, the catalyst calendar system 106 can leverage past patterns and outcomes to inform scheduling decisions for calendar events associated with the execution timeframe 470. In some cases, the catalyst calendar system 106 gathers data from past calendar events including dates, times, participants, locations, durations, outcomes, and feedback provided post-calendar event. To illustrate, by analyzing historical performance and patterns, the catalyst calendar system 106 can compare scheduled calendar events associated with accomplishing the target objective with historical calendar events associated with accomplishing target objectives to determine a missing executable task to accomplish the target objective within the execution timeframe 470. As mentioned, the catalyst calendar system 106 can determine a missing calendar event (and/or executable task) to accomplish the “Target Objective A” within the execution timeframe 470 and provide the computer code 420 to add a new calendar event “Event 6.”

Furthermore, using pattern recognition of the historical data, the catalyst calendar system 106 can predict and account for potential issues with new calendar events before they occur. To illustrate, the catalyst calendar system 106 analyzes historical data to identify patterns such as: certain types of meetings often getting extended, certain collaborations are productive at specific times of day, or certain calendar event types frequently get rescheduled. For instance, if a calendar event for a meeting with a Client X usually overruns its allotted time, the catalyst calendar system 106 can automatically schedule a longer slot for the next meeting with Client X. Through this historical analysis, the catalyst calendar system 106 actively learns from past calendar events, scheduling calendar events (as represented on the execution timeframe 470) tailored to historical user account patterns, productivity, and preferences.

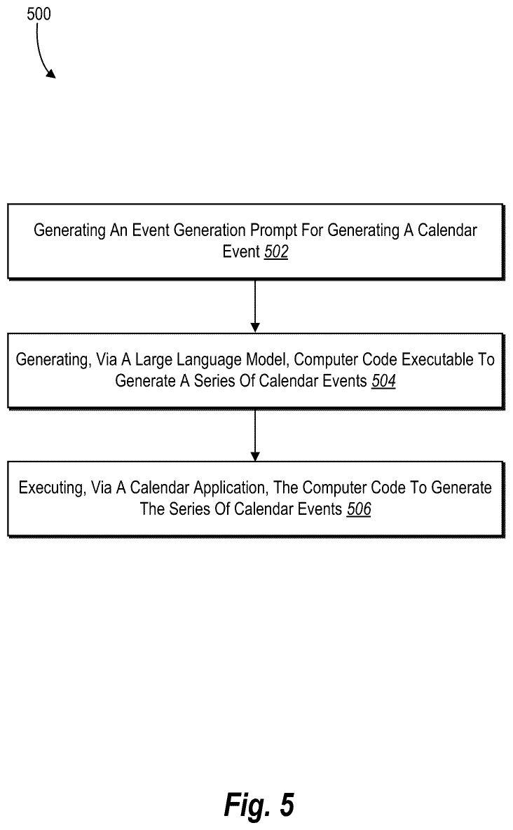

FIGS. 1-4B, the corresponding text, and the examples provide a number of different systems and methods for providing a catalyst calendar interface. In addition to the foregoing, implementations can also be described in terms of flowcharts comprising acts/steps in a method for accomplishing a particular result. For example, FIG. 5 illustrates an example series of acts for generating and providing a providing a catalyst calendar interface displaying an event element in accordance with one or more embodiments.

As illustrated in FIG. 5, the series of acts 500 may include an act 502 of generating an event generation prompt for generating a calendar event. For example, in one or more embodiments, the act 502 can include generating an event generation prompt comprising textual instructions for generating, using a large language model, a calendar event corresponding to a target objective. In addition, the series of acts 500 includes an act 504 of generating, via a large language model, computer code executable to generate a series of calendar events. For example, in one or more embodiments, the act 504 can include in response to the event generation prompt, generating, via the large language model, a task curriculum comprising a set of executable tasks whose completion accomplishes the target objective. For example, in one or more embodiments, the act 504 can include in response to the event generation prompt, generating, via the large language model, computer code executable by a calendar application to generate a series of calendar events corresponding to the set of executable tasks in the task curriculum. As further illustrated in FIG. 5, the series of acts 500 includes an act 506 of executing, via a calendar application, the computer code to generate the series of calendar events. In one or more embodiments, as described above, the act 506 can include executing, via the calendar application, the computer code to generate the series of calendar events for completing the task curriculum.

In addition, in one or more embodiments, the series of acts 500 includes determining an execution timeframe for completing the target objective. Additionally, in one or more embodiments, the series of acts 500 includes determining a series of event durations for completing the series of calendar events within the execution timeframe. Furthermore, in one or more embodiments, the series of acts 500 includes generating, from a knowledge graph defining relationships among the set of executable tasks, a prompt modifier for generating the event generation prompt according to data indicated by the knowledge graph. Further, in one or more embodiments, the series of acts 500 includes generating the event generation prompt based on providing the prompt modifier with the event generation prompt.

In addition, in one or more embodiments, the series of acts 500 includes generating the computer code to order the set of executable tasks based on the relationships among the set of executable tasks. Additionally, in one or more embodiments, the series of acts 500 includes determining available time intervals within the calendar application based on a priority of the target objective. Moreover, in one or more embodiments, the series of acts 500 includes executing, via the calendar application, the computer code to generate the series of calendar events by scheduling the series of calendar events within the available time intervals.

Further, in one or more embodiments, the series of acts 500 includes determining priorities of scheduled calendar events within the calendar application. In addition, in one or more embodiments, the series of acts 500 includes generating additional computer code for rearranging the scheduled calendar events within the calendar application according to the priorities. In one or more embodiments, the series of acts 500 includes executing, via the calendar application, the additional computer code for rearranging the scheduled calendar events based on the priorities of the scheduled calendar events within the calendar application. Moreover, in one or more embodiments, the series of acts 500 includes automatically executing an executable task of the set of executable tasks by communicating with one or more external models.

Further, in one or more embodiments, the series of acts 500 includes generating an event generation prompt comprising textual instructions for generating, using a large language model, a calendar event corresponding to a target objective. In addition, in one or more embodiments, the series of acts 500 includes, in response to the event generation prompt, generating via the large language model, a task curriculum comprising a set of executable tasks whose completion accomplishes the target objective. Additionally, in one or more embodiments, the series of acts 500 includes associating the set of executable tasks with a series of calendar events including the calendar event corresponding to the target objective. Furthermore, in one or more embodiments, the series of acts 500 includes, in response to the event generation prompt, generating via the large language model, computer code executable by a calendar application to generate the calendar event. Further, in one or more embodiments, the series of acts 500 includes executing, via the calendar application, the computer code to generate the calendar event.

In addition, in one or more embodiments, the series of acts 500 includes determining, utilizing the large language model, an additional calendar event among the series of calendar events. Additionally, in one or more embodiments, the series of acts 500 includes executing, via the calendar application, additional computer code to generate the additional calendar event ordered within the calendar application based on a relation of the additional calendar event to the series of calendar events. Moreover, in one or more embodiments, the series of acts 500 includes determining background event parameters from one or more connectors integrating application data from one or more external computer applications. Further, in one or more embodiments, the series of acts 500 includes generating the event generation prompt based on the background event parameters.

In addition, in one or more embodiments, the series of acts 500 includes generating, via the large language model, additional computer code executable by the calendar application to set an interval of time allocated to the calendar event. In one or more embodiments, the series of acts 500 includes executing, via the calendar application, the additional computer code to set the interval of time allocated to the calendar event. Moreover, in one or more embodiments, the series of acts 500 includes modifying, in response to a change in the series of calendar events, the calendar event for completing the task curriculum.

Further, in one or more embodiments, the series of acts 500 includes determining, based on communicating with the calendar application, an available collaborative time interval for scheduling the calendar event comprising a time interval that is available for a first user account and a second user account. In addition, in one or more embodiments, the series of acts 500 includes generating, via the large language model, first computer code to generate the calendar event on the calendar application during the available collaborative time interval for the first user account. Additionally, in one or more embodiments, the series of acts 500 includes generating, via the large language model, second computer code to request scheduling the calendar event on the calendar application during the available collaborative time interval for the second user account. Furthermore, in one or more embodiments, the series of acts 500 includes executing, via the calendar application, the first computer code to generate a first instance of the calendar event for the first user account. Further, in one or more embodiments, the series of acts 500 includes executing, via the calendar application, the second computer code to request scheduling a second instance of the calendar event for the second user account. In addition, in one or more embodiments, the series of acts 500 includes generating the event generation prompt based on analyzing terminology of an event input to determine the target objective corresponds to an execution timeframe.

Additionally, in one or more embodiments, the series of acts 500 includes generating an event generation prompt comprising textual instructions for generating, using a large language model, a calendar event corresponding to a target objective. Moreover, in one or more embodiments, the series of acts 500 includes, in response to the event generation prompt, generating, via the large language model, a task curriculum comprising a set of executable tasks whose completion accomplishes the target objective. Further, in one or more embodiments, the series of acts 500 includes, in response to the event generation prompt, generating, via the large language model, computer code executable by a calendar application to generate the calendar event corresponding to an executable task among the set of executable tasks in the task curriculum. In addition, in one or more embodiments, the series of acts 500 includes executing, via the calendar application, the computer code to generate the calendar event for completing the task curriculum.

In one or more embodiments, the series of acts 500 includes determining an incomplete status of the target objective based on a status of the set of executable tasks. Moreover, in one or more embodiments, the series of acts 500 includes generating, via the large language model, additional computer code executable by the calendar application to generate an additional calendar event for completing the task curriculum. Further, in one or more embodiments, the series of acts 500 includes executing, via the calendar application, the additional computer code to generate the additional calendar event to complete the task curriculum. In one or more embodiments, the series of acts 500 includes comparing the task curriculum with a scheduled calendar event to determine that the scheduled calendar event is associated with accomplishing the target objective. Moreover, in one or more embodiments, the series of acts 500 includes generating, via the large language model, additional computer code to associate the scheduled calendar event with the set of executable tasks whose completion accomplishes the target objective.

Further, in one or more embodiments, the series of acts 500 includes comparing scheduled calendar events associated with accomplishing the target objective with historical calendar events associated with accomplishing target objectives to determine a missing executable task to accomplish the target objective within an execution timeframe. In one or more embodiments, the series of acts 500 includes generating, via the large language model, additional computer code executable by the calendar application to generate the missing calendar event for completing the task curriculum. Moreover, in one or more embodiments, the series of acts 500 includes executing, via the calendar application, the additional computer code to generate the missing calendar event.

Further, in one or more embodiments, the series of acts 500 includes determining an amount of time for completing the target objective. In one or more embodiments, the series of acts 500 includes generating, via the large language model, additional computer code to allocate the amount of time for completing the target objective to the series of calendar events. Moreover, in one or more embodiments, the series of acts 500 includes executing, via the calendar application, the additional computer code to allocate the amount of time to the series of calendar events. Further, in one or more embodiments, the series of acts 500 includes determining, utilizing the large language model, a priority for the set of executable tasks based on a relationship between the set of executable tasks and scheduled calendar events. In one or more embodiments, the series of acts 500 includes generating, the computer code executable by the calendar application to generate the series of calendar events based on the priority of the set of executable tasks.

### Catalyst Calendar Interface

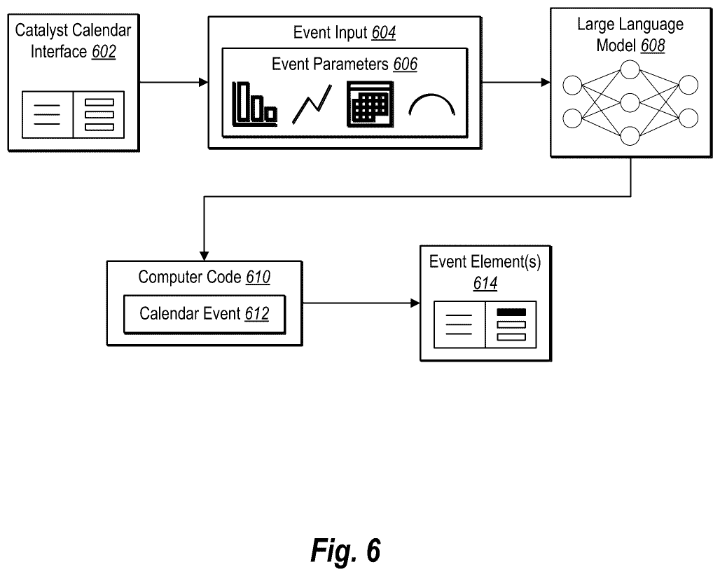

As mentioned, the catalyst calendar system 106 also provides custom graphical user interfaces for generating and managing calendar structures using a combination of a chat window and an integrated calendar window. In particular, the catalyst calendar system 106 generates a first-of-its kind catalyst calendar interface that includes elements for interacting with a large language model together with elements for viewing and modifying rich calendar content of a calendar application. FIG. 6 illustrates an example overview of the catalyst calendar system 106 providing a catalyst calendar interface for display in accordance with one or more embodiments. Additional detail regarding the various acts and processes mentioned in relation to FIG. 6 is provided thereafter with reference to subsequent figures.

As illustrated in FIG. 6, the catalyst calendar system 106 can generate a catalyst calendar interface 602 for display on a client device. In particular, the catalyst calendar system 106 can generate the catalyst calendar interface 602 for interfacing between a client device and a large language model 608 to generate event element(s) 614 for display on the client device. The catalyst calendar interface 602 is a specialized interface that incorporates a combination of a chat window and an integrated calendar window to streamline client device interaction with the calendar application. The chat window of the catalyst calendar interface 602 is dedicated to facilitating client device interaction, enabling the catalyst calendar system 106 to receive event input 604 for managing calendar events. For example, the catalyst calendar system 106 utilizes the chat window to provide content to and accept input from a client device to generate calendar events based on target objectives. Concurrently, the catalyst calendar system 106 utilizes the integrated calendar window to integrate with the calendar application and display the calendar events as event element(s) 614 in a rich calendar format. For example, the integrated calendar window content includes a detailed presentation of calendar events, descriptions of calendar events, and intelligent suggestions for calendar events.

Within the catalyst calendar interface 602, the catalyst calendar system 106 provides an interactive element to receive event input 604. As shown, the client device can provide digital content (e.g., in the form of the event input 604) to interface with the calendar application through the large language model 608. For example, the catalyst calendar system 106 can analyze the event input 604 to determine one or more of event parameters 606 that include parameters for generating a series of calendar events based on accomplishing a target objective.

Furthermore, the catalyst calendar system 106 can generate one or more of the event parameters 606 based on client device configuration, historical data, knowledge graphs, and/or connectors. In turn, the catalyst calendar system 106 can generate the computer code 610 utilizing the large language model 608 to process the event parameters 606. For example, in response to receiving the event input 604 of “Schedule a recurring team synchronization meeting to discuss Project A,” the catalyst calendar system 106 can determine parameters for generating calendar events for the recurring team meeting based on the target objective of completing Project A.

Further, the catalyst calendar system 106 can generate an event generation prompt based on the event parameters 606. To illustrate, based on analyzing the target objective of completing Project A, the catalyst calendar system 106 can determine an event duration, event frequency, event time, event participants, meeting agenda, related events, and possible event conflicts for scheduling a series of calendar events to complete project A (each event corresponding to a task in a task curriculum deconstructed from the target objective). Based on the determination of the event parameters 606 for one of the events in the series, the catalyst calendar system 106 can generate an event generation prompt such as “Create an API that schedules a new ‘Team Sync’ calendar event in the calendar application for every Monday at 10 AM. The function should request user input for the meeting duration and check for conflicts with existing calendar events before scheduling. The API must handle authentication, process successful API call responses, and report any exceptions or errors that occur during scheduling.”

As shown in FIG. 6, based on the event generation prompt, the large language model 608 generates the computer code 610. In particular, the large language model 608 generates the computer code 610 to cause the calendar application to interact with one or more of the calendar event(s) 612 within the context of the target objective of completing Project A within an execution timeframe. For example, the catalyst calendar system 106 utilizes the computer code 610 to interface with the calendar application to cause the calendar application to add, modify, delete, update, and/or display one or more of the calendar event(s) 612. If the catalyst calendar system 106 determines that the large language model 608 requires additional information to generate the computer code 610, the catalyst calendar system 106 suspends and/or interrupts the generation of the computer code 610 and prompts the client device to provide the additional information. As a result of receiving the additional information (or an indication the additional information is not available), the catalyst calendar system 106 can resume operation and generate the computer code 610 utilizing the additional information (or based on the lack of additional information).

Moreover, the catalyst calendar system 106 displays the calendar event(s) 612 utilizing event element(s) 614 by incorporating rich calendar content within the integrated calendar window of the catalyst calendar interface 602. For example, the catalyst calendar system 106 can provide the integrated calendar window to display the calendar events in conjunction with the chat window. In particular, the catalyst calendar system 106 provides the integrated calendar window that reflects the calendar event(s) 612 generated by the calendar application based on the computer code 610 in real time. Indeed, the catalyst calendar system 106 provides a multi-window interface which seamlessly integrates the chat window and an integrated calendar window for the addition, review, and modification of calendar events with minimal client device interactions.

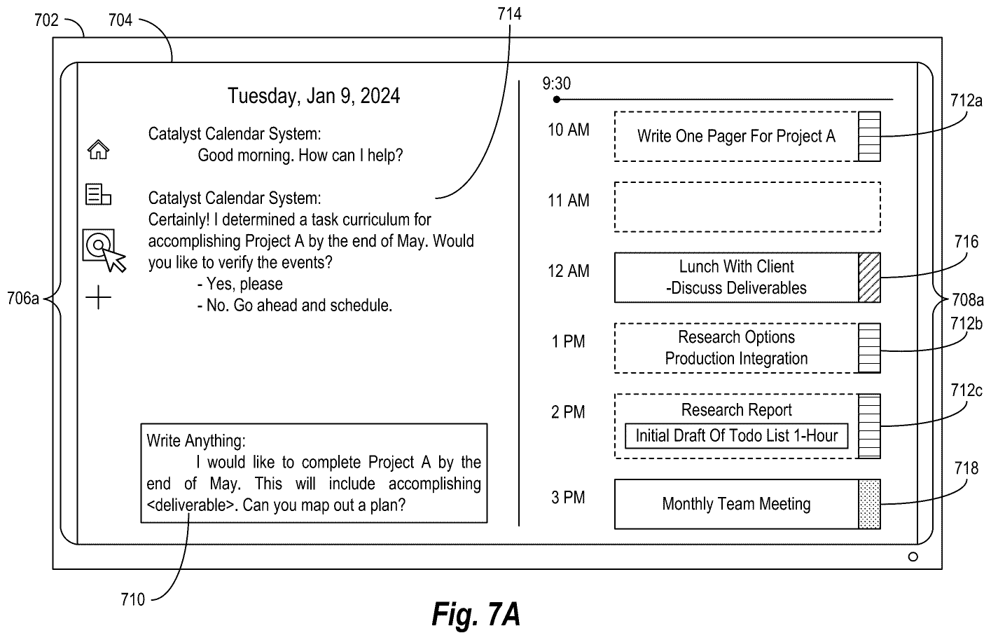

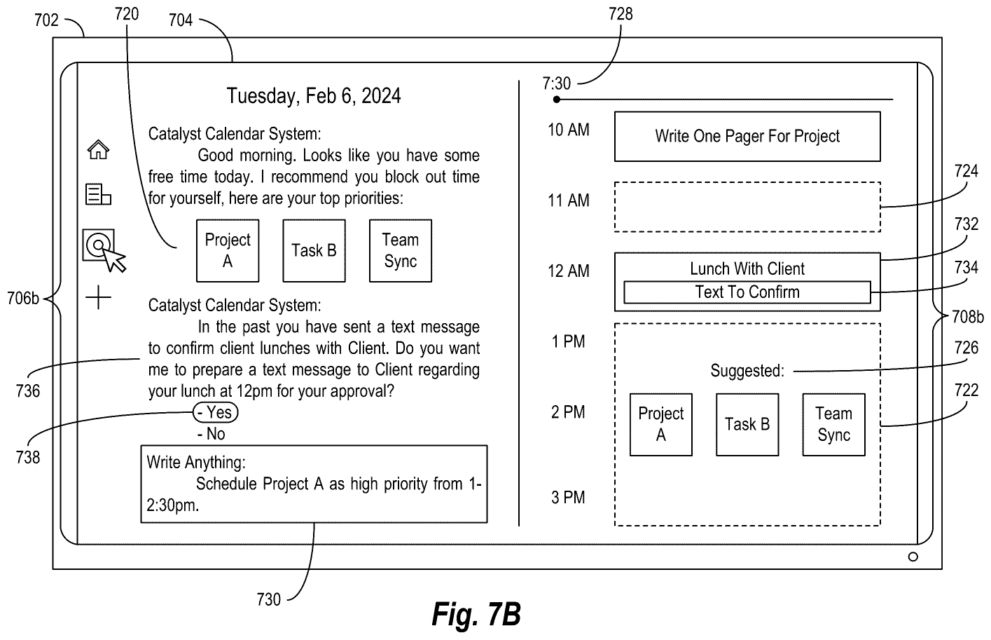

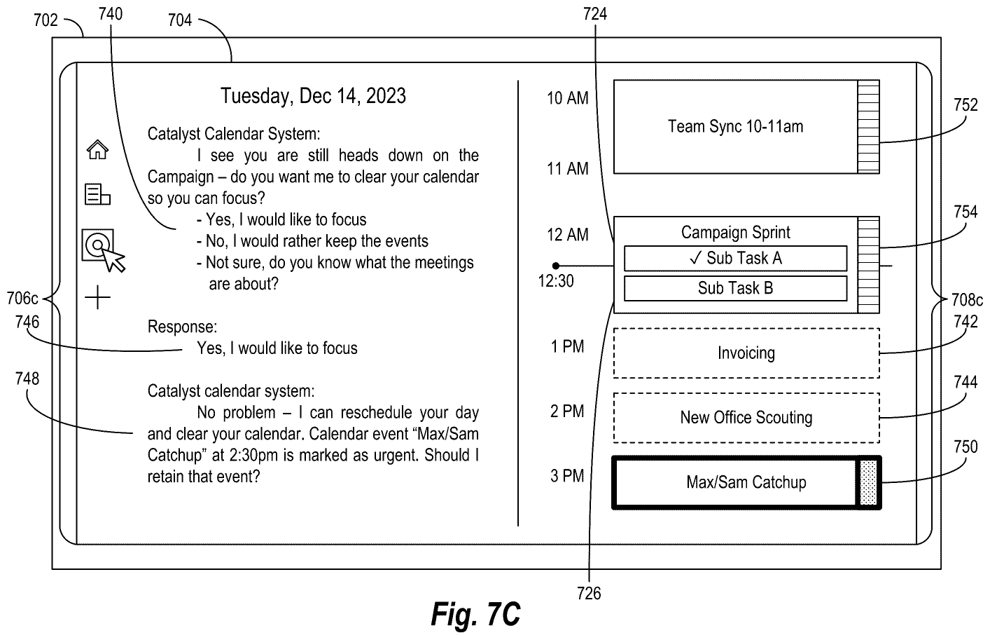

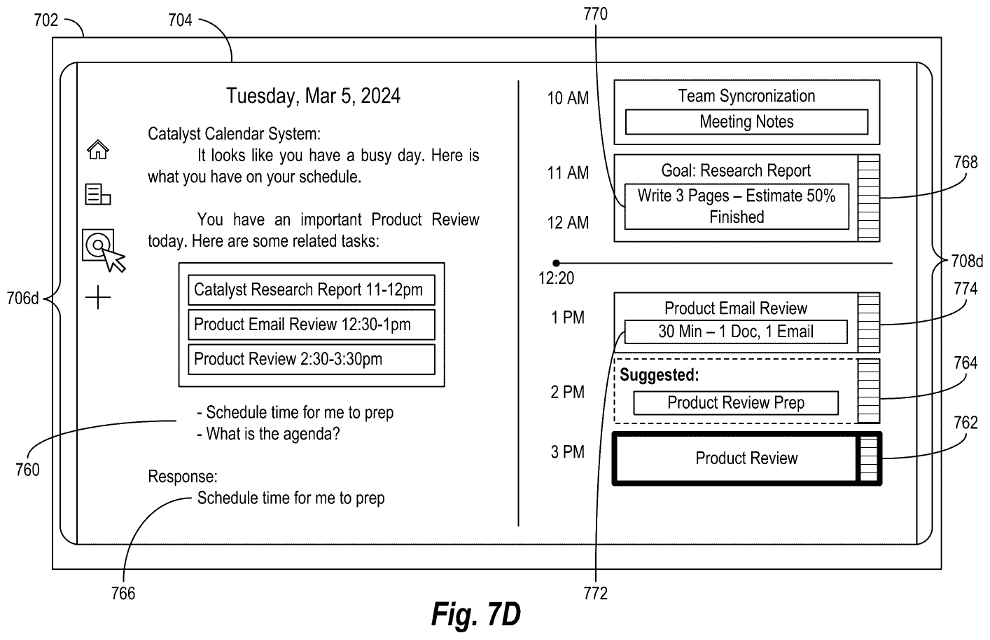

As mentioned, the catalyst calendar system 106 provides an interactive and interrelated multi-window interface designed to streamline calendar event creation based on target objectives. FIGS. 7A-7D illustrate example catalyst calendar interfaces for generating, scheduling, and interacting with a series of calendar events in accordance with one or more embodiments.

As shown in FIG. 7A, the catalyst calendar system 106 generates and provides a catalyst calendar interface 704 for display on a client device 702. As shown, the catalyst calendar interface 704 includes a chat window 706a to streamline communication between the client device 702 and a calendar application using a machine learning model. For example, the chat window 706a provides a view of an ongoing conversation with the large language model, including previously entered prompts and corresponding responses, confirming actions taken by the catalyst calendar system 106 or asking for clarifications on client device 702 requests. In particular, the chat window 706a serves as the interactive interface for the client device 702 to accept input, ask questions, or issue commands related to the calendar events.

As further shown, the catalyst calendar interface 704 generates and provides an integrated calendar window 708a that functions in conjunction with the chat window 706a and presents calendar events utilizing rich calendar content. For example, the integrated calendar window 708a provides a visual representation of the calendar events, showing existing calendar events as well as demonstrating how new or modified calendar events will fit into the schedule. In some cases, the integrated calendar window 708a presents rich content ingested or embedded from a separate calendaring application, incorporating the content directly into the catalyst calendar interface. As the client device 702 interacts with the chat window 706a, the integrated calendar window 708a updates calendar events in real time to reflect the changes, providing a constantly up-to-date view of the scheduled calendar events or proposed calendar events. Furthermore, the catalyst calendar system 106 shares contextual information between the chat window 706a and the integrated calendar window 708a. As an example, if a user discusses details related to “Project X” in the chat window 706a, the catalyst calendar system 106 can highlight all calendar events related to “Project X” in the integrated calendar window 708a.

As mentioned, the catalyst calendar system 106 displays the calendar events within the integrated calendar window 708a utilizing rich calendar content. In particular, the calendar events can include rich calendar content associated with tasks related to accomplishing target objectives. For example, the calendar events can include comprehensive information about the calendar event, including the related tasks, event purpose, event agenda, detailed event description, and event background information. Furthermore, the calendar events can include multimedia attachments including related documents, images, links to relevant resources, or multimedia that provide context or reading associated with the calendar event (and/or target objective). In addition, the calendar events can include links to join virtual meetings, interactive elements, or executable tasks associated with the calendar events. In some cases, the catalyst calendar system 106 creates custom fields, event associations, and/or priority levels that help in visually categorizing and understanding the calendar event place within larger workflows and/or target objectives.

As described above in relation to FIGS. 2-4B, based on event input 710, the catalyst calendar system 106 generates actionable computer code to interface with the calendar application. In particular, the catalyst calendar system 106 receives, via the chat window 706a of the catalyst calendar interface 704, the event input 710 utilizing a text input field for interacting with the large language model through text prompts. When the client device 702 interacts with the event input 710, the catalyst calendar system 106 can extract parameters used by a large language model generate code to create calendar events and/or modify calendar events. Furthermore, the catalyst calendar system 106 displays the calendar events within the integrated calendar window 708a.

To illustrate, as shown in FIG. 7A, in response to the event input 710, the catalyst calendar system 106 generates a series of calendar events (e.g., calendar event 712a, calendar event 712b, calendar event 712c which all have the same hatching pattern) whose completion accomplishes a target objective (e.g., where different target objectives correspond to different hatching patterns, colors, or other visual indicators of calendar events). In particular, the catalyst calendar system 106 can utilize the chat window 706a to receive an event input 710 of “I would like to complete Project A by the end of May. This will include accomplishing <deliverable>. Can you map out a plan?” As a result, the catalyst calendar system 106 can evaluate the event input 710 and determine a “Project A” task curriculum to accomplish the target objective of “Project A.” The “Project A” task curriculum includes a series of tasks that correspond to the common overarching goal or “Project A” (e.g., “complete Project A by the end of May”). In turn, the catalyst calendar system 106 can utilize the large language model to generate computer code to interface with the calendar application and determine time intervals for scheduling “Project A” calendar events based on the “Project A” task curriculum. In turn, the catalyst calendar system 106 can cause the calendar application to generate the calendar events for “Project A” for display within the integrated calendar window 708a (e.g., calendar event 712a, calendar event 712b, calendar event 712c).

In some cases, the catalyst calendar system 106 can automatically schedule and display calendar events associated with the target objective. For example, the catalyst calendar system 106 can schedule and display the Project A calendar events as shown by calendar event 712a, calendar event 712b, and calendar event 712c without further interaction from the client device 702. In some cases, the catalyst calendar system 106 can request client authorization (e.g., selectable element 714) for the scheduling Project A calendar events before scheduling the calendar event 712a, calendar event 712b, and calendar event 712c within the calendar application. In either case, the calendar event 712a, calendar event 712b, and calendar event 712c correspond with calendar events generated to complete Project A within the requested timeframe.

Furthermore, the catalyst calendar system 106 can visually associate calendar events with target objectives. As shown in FIG. 7A, the integrated calendar window 708a displays the calendar event 712a, the calendar event 712b, and the calendar event 712c utilizing a similar visual indication which corresponds to calendar events associated with completing Project A. As also shown, the integrated calendar window 708a displays the calendar event 716 utilizing a visual indication which corresponds to calendar events associated with client networking. As also shown, the integrated calendar window 708a displays the calendar event 718 utilizing a visual indication which corresponds to calendar events associated with team welfare. In some cases, the catalyst calendar system 106 can provide an interactive element to provide elements designed for in-depth review and analysis of past and upcoming calendar events. Furthermore, the catalyst calendar system 106 can provide explanatory information within the catalyst calendar interface 704 including descriptions of how the calendar events impact the accomplishment of one or more target objectives.

In addition, the catalyst calendar system 106 can interact with the client device to schedule collaborative calendar events. For example, the catalyst calendar system 106 utilizes a large language model to determine a collaborative time interval for scheduling a collaborative calendar event associated with a first user account and a second user account. Based on the determination, the catalyst calendar system 106 can provide a selectable option within the chat window 706a to schedule the collaborative calendar event within the collaborative time interval. Furthermore, the catalyst calendar system 106 can receive a selection of the selectable option to schedule the collaborative event. In turn, the catalyst calendar system 106 can provide, for display within the integrated calendar window 708a the collaborative calendar event (e.g., calendar event 718) within the collaborative time interval.

Turning to FIG. 7B, the catalyst calendar system 106 can interact with the client device concerning calendar events within the chat window 706b. In particular, the catalyst calendar system 106 can communicate with the calendar application to generate and display suggestions related to adding calendar events which are associated with accomplishing one or more target objectives. Furthermore, the catalyst calendar system 106 can provide calendar suggestions 720 for scheduling additional calendar events (e.g., Project A, Task B, or Team Sync) associated with one or more target objectives within one or more of the available time intervals. In some cases, the calendar suggestions 720 can be individual calendar events. In some cases, the calendar suggestions 720 can include a series of calendar events.

Relatedly, the catalyst calendar system 106 generate computer code based on input from the client device 702 to schedule calendar events. For example, the catalyst calendar system 106 can receive event input 730 indicating a time interval to schedule an additional calendar event (e.g., “Schedule Project A as high priority from 1-2:30 pm”). In some cases, the catalyst calendar system 106 can accept input (e.g., client device 702 interaction, client device 702 mouse click, event input 730) selecting one or more additional calendar events from the calendar suggestions 720 and automatically generate code for one or more associated calendar events for display within an available time interval. In some cases, the catalyst calendar system 106 can accept additional input regarding the calendar suggestions 720 to generate code to schedule one or more additional calendar events from the calendar suggestions 720.

As also shown, the catalyst calendar system 106 can visually interact with the client device by providing rich calendar content within the integrated calendar window 708b. For example, the catalyst calendar system 106 can provide rich calendar content for calendar events scheduled for event durations within time intervals in relation to a current time 728. In addition, the catalyst calendar system 106 can display available time intervals (e.g., time interval 722 and time interval 724) in relation to a current time 728. Integrated with the visual display of scheduled calendar events and available time intervals, the catalyst calendar system 106 can provide calendar event suggestions 726 within time interval 722. Furthermore, based on a client device 702 interaction, the catalyst calendar system 106 can generate code for one or more associated calendar events for display within the time interval 722. In this way, the catalyst calendar system 106 can visually communicate and manage suggestions for scheduling calendar events within available time intervals of the calendar application utilizing the integrated calendar window 708b.

Furthermore, the catalyst calendar system 106 can receive input from the client device 702 and execute tasks associated with calendar events. To illustrate, the catalyst calendar system 106 can generate and display a task 734 of “Text to Confirm” associated with calendar event 732 of “Lunch with Client.” Further, the catalyst calendar system 106 can generate and display a suggestion 736 to generate a text message about the calendar event 732 of “Lunch with Client.” In response to the suggestion 736, the catalyst calendar system 106 can receive an interaction from the client device 702 of “Yes” selecting the selectable option 738. Alternatively, the catalyst calendar system 106 can receive an interaction from the client device 702 selecting task 734 associated with the integrated calendar window 708b. In either case, based on a client device interaction, the catalyst calendar system 106 can generate computer code to communicate with an external model to send a text message as described in relation to FIG. 4A.

Turning to FIG. 7C, the catalyst calendar system 106 can interact with the client device 702 to modify calendar events utilizing the chat window 706c. For example, the catalyst calendar system 106 can generate and display suggestions for modifying calendar events based upon accomplishing one or more target objectives (and associated task curriculum) within an execution timeframe. In some cases, the catalyst calendar system 106 can generate and display suggestions for modifying individual calendar events (e.g., adding time, removing time, rescheduling, removing, adding associated events). In some cases, the catalyst calendar system 106 can generate suggestions for modifications to multiple calendar events. To illustrate, based on determining that a target objective associated with certain calendar events has higher priority than scheduled calendar events, the catalyst calendar system 106 can generate and display selectable element 740.

As further shown in FIG. 7C, the catalyst calendar system 106 can display suggested modifications to calendar events within the integrated calendar window 708c. For example, the catalyst calendar system 106 can display calendar event 742 and calendar event 744 in a way to indicate a recommendation by the catalyst calendar system 106 to modify/delete/reschedule the calendar event. For example, the catalyst calendar system 106 can represent the calendar events with a dashed border, a transparent/faded appearance, a specific color, and/or strikethrough text. In some cases, the catalyst calendar system 106 can indicate suggestions to modify/delete/reschedule calendar events within the integrated calendar window 708c in other ways such as providing a pop-up indication or placing calendar events in a dedicated section.

Furthermore, based on receiving an interaction from the client device, the catalyst calendar system 106 can generate code to modify calendar events to prioritize a target objective. For example, the catalyst calendar system 106 can receive a client device selection of the selectable option 746 indicating a request to modify calendar events based on accomplishing the “Campaign” target objective. In response, the catalyst calendar system 106 can generate code to modify one or more calendar events. As shown, the catalyst calendar system 106 can remove/reschedule/adjust calendar event 744 and calendar event 750 which are not associated with the “Campaign” target objective. As also shown, the catalyst calendar system 106 can retain calendar event 752 and calendar event 754 which are associated with completing the “Campaign” target objective (as visually indicated in the integrated calendar window 708c).

As shown in FIG. 7C, the catalyst calendar system 106 can utilize priority values of calendar events within the catalyst calendar interface 704. For example, the catalyst calendar system 106 can determine the calendar event 750 has a high priority based on event parameters, a comparison to other calendar events, an associated target objective, analyzing historical data, receiving client device input, and/or other methods. As shown in FIG. 7C, the catalyst calendar system 106 can visually indicate the calendar event 750 has a high priority as shown in the integrated calendar window 708c by a bold outline. Furthermore, based on the priority of the calendar event 750, the catalyst calendar system 106 can prioritize the calendar event 750 within the event timeline (e.g., calendar schedule). As also shown, based on the priority of the calendar event 750, the catalyst calendar system 106 can interact with the client device 702 (e.g., using prompt 748) to determine whether to retain (or replace) calendar event 750 within the scheduled time interval.

As mentioned, the catalyst calendar system 106 can utilize rich calendar content for the calendar events within the integrated calendar window 708c to display how calendar events impact the accomplishment of target objectives. For example, the integrated calendar window 708c can provide rich calendar content including visual indications of associations with (and/or interactive elements for) tasks, target objectives, or associated calendar events. For example, the catalyst calendar system 106 can provide a detailed description of calendar event 754 within the integrated calendar window 708c or based on a client device interaction with the calendar event 754. As shown, the catalyst calendar system 106 can display elements associated with a target objective for the calendar event 754 including a completion status of “Sub Task A” and “Sub Task B” associated with the calendar event 754.

Turning to FIG. 7D, the catalyst calendar system 106 can interact with the client device to generate computer code to modify calendar events based on target objectives. As shown, the catalyst calendar system 106 can provide suggestions within the chat window 706d to modify calendar events based on target objectives. To elaborate, the catalyst calendar system 106 can interface with the calendar application to monitor a completion status of a target objective. Furthermore, the catalyst calendar system 106 can determine that completing a target objective requires adding calendar events and/or modifying the time allocated to calendar events. Based on this determination, the catalyst calendar system 106 can interact with the client device 702 to provide a selectable element 760 which includes the option of “Schedule time for me to prep.” In this way, the catalyst calendar system 106 can provide intelligent event scheduling suggestions to accomplish the target objective associated with the upcoming “Product Review” for calendar event 762.

Furthermore, the catalyst calendar system 106 can display recommendations for calendar events relating to target objectives within the integrated calendar window 708d. For example, the catalyst calendar system 106 can identify a time interval for adding a calendar event 764 and display the placement of the calendar event 764 during the recommended time interval. Notably, the catalyst calendar system 106 can display the rich calendar content of the calendar event 764 to visually reflect an association between the calendar event 764 and a target objective (e.g., the target objective related to the calendar event 762).

Relatedly, the catalyst calendar system 106 can display granular tasks related to calendar events associated with the target objective. For example, the catalyst calendar system 106 can provide the task 770 of “Write 3 pages” for the calendar event 768. As also shown, the catalyst calendar system 106 can provide the task 772 of “30 Min-1 Doc, 1 Email” for the calendar event 774. In this way, the catalyst calendar system 106 can provide additional granular support for completing the target objectives utilizing the calendar events.

As also shown, the catalyst calendar system 106 can receive, and act based on, event input associated with scheduling calendar events. For example, the catalyst calendar system 106 can receive event input 766 indicating a selection of the selectable element 760 (e.g., “Schedule time for me to prep”) to schedule an additional calendar event. In some cases, the catalyst calendar system 106 can accept input (e.g., client device 702 interaction, mouse click) accepting the suggestion to add the calendar event 764 displayed within the integrated calendar window 708d. Furthermore, based on the event input 766, the catalyst calendar system 106 can display within the integrated calendar window 708d, additional rich calendar content including a representation of the calendar event 764 during the available time interval.

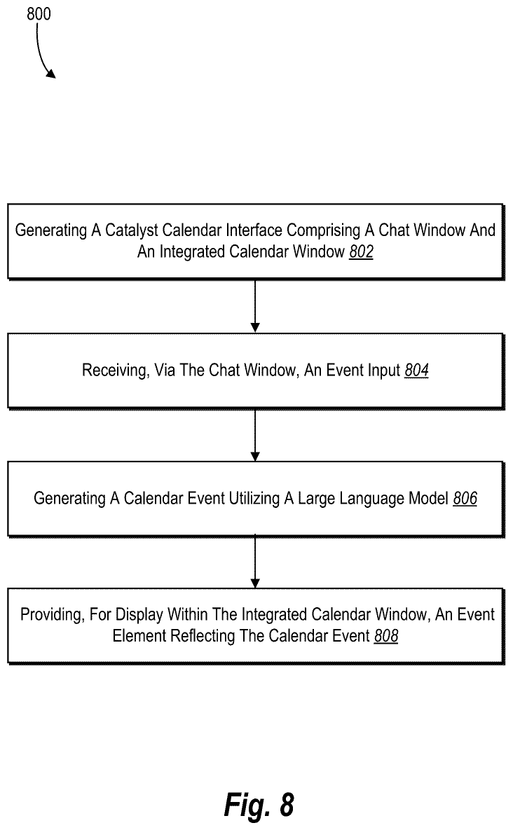

FIGS. 5-7D, the corresponding text, and the examples provide a number of different systems and methods for providing a catalyst calendar interface. In addition to the foregoing, implementations can also be described in terms of flowcharts comprising acts/steps in a method for accomplishing a particular result. For example, FIG. 8 illustrates an example series of acts for generating and providing a providing a catalyst calendar interface displaying an event element.

As illustrated in FIG. 8, the series of acts 800 may include an act 802 of generating a catalyst calendar interface comprising a chat window and an integrated calendar window. For example, in one or more embodiments, the act 802 can include generating, for display on a client device, a catalyst calendar interface comprising a chat window and an integrated calendar window. In addition, the series of acts 800 includes an act 804 of receiving, via the chat window, an event input. For example, in one or more embodiments, the act 804 can include receiving, via the chat window of the catalyst calendar interface, an event input indicating event parameters for a calendar event. As further illustrated in FIG. 8, the series of acts 800 includes an act 806 of generating a calendar event utilizing a large language model. In one or more embodiments, as described above, the act 806 can include, in response to receiving the event input, generating the calendar event utilizing a large language model to process the event parameters. For example, in one or more embodiments, the act 808 can include providing, for display within the integrated calendar window, an event element. In one or more embodiments, as described above, the act 808 can include providing, for display within the integrated calendar window of the catalyst calendar interface, an event element comprising rich calendar content presented within an integrated view of a calendar application, wherein the rich calendar content reflects the calendar event generated by the large language model.

Further, in one or more embodiments, the series of acts 800 includes receiving, via the chat window of the catalyst calendar interface, the event input via a text input field for interacting with the large language model through text prompts. In addition, in one or more embodiments, the series of acts 800 includes generating, for display via the chat window of the catalyst calendar interface, a selectable option comprising a recommendation to execute an executable task associated with the calendar event. Furthermore, in one or more embodiments, the series of acts 800 includes receiving, via the chat window of the catalyst calendar interface, a selection of the selectable option. Additionally, in one or more embodiments, the series of acts 800 includes, based on the selection, executing the executable task by communicating with one or more external models.

Moreover, in one or more embodiments, the series of acts 800 includes generating, for display via the chat window of the catalyst calendar interface, an indication of a target objective associated with the calendar event and a selectable option associated with modifying the calendar event based on the target objective. Further, in one or more embodiments, the series of acts 800 includes receiving, via the chat window of the catalyst calendar interface, a selection of the selectable option. Furthermore, in one or more embodiments, the series of acts 800 includes. Moreover, in one or more embodiments, the series of acts 800 includes generating, via the large language model, a modified calendar event from the calendar event based on the selection of the selectable option. Additionally, in one or more embodiments, the series of acts 800 includes providing the modified calendar event for display within the integrated calendar window of the catalyst calendar interface, the modified calendar event.

Moreover, in one or more embodiments, the series of acts 800 includes generating, via the large language model and in response to the event input, a series of calendar events comprising the calendar event and whose completion accomplishes a target objective. In addition, in one or more embodiments, the series of acts 800 includes providing, for display within the integrated calendar window of the catalyst calendar interface, an additional event element comprising additional rich calendar content presented within the integrated view of the calendar application, wherein the additional rich calendar content reflects an additional calendar event generated by the large language model. Additionally, in one or more embodiments, the series of acts 800 includes determining, based on the event input, a target objective corresponding to the calendar event. Furthermore, in one or more embodiments, the series of acts 800 includes a visual indication of a correlation between the calendar event and the target objective.

Moreover, in one or more embodiments, the series of acts 800 includes generating, for display on a client device, a catalyst calendar interface comprising a chat window and an integrated calendar window. In addition, in one or more embodiments, the series of acts 800 includes receiving, via the chat window of the catalyst calendar interface, an event input indicating event parameters for a calendar event. Furthermore, in one or more embodiments, the series of acts 800 includes causing, in response to receiving the event input, a large language model to generate the calendar event based on the event parameters. Moreover, in one or more embodiments, the series of acts 800 includes providing, for display within the integrated calendar window of the catalyst calendar interface, an event element comprising rich calendar content presented within an integrated view of a calendar application, wherein the rich calendar content reflects the calendar event generated by the large language model.

Additionally, in one or more embodiments, the series of acts 800 includes providing, via the integrated calendar window, the event element comprising the calendar event scheduled for an event duration within an available time interval in relation to a current time. Further, in one or more embodiments, the series of acts 800 includes determining, from one or more connectors integrating data from external computer applications, background event parameters defining scheduling preferences for generating the calendar event. Moreover, in one or more embodiments, the series of acts 800 includes arranging, for display within the integrated calendar window of the catalyst calendar.

Additionally, in one or more embodiments, the series of acts 800 includes determining, utilizing the large language model, a collaborative time interval for scheduling the calendar event for a first user account and a second user account. Further, in one or more embodiments, the series of acts 800 includes providing, via the chat window of the catalyst calendar interface, a selectable option to schedule the calendar event within the collaborative time interval. Moreover, in one or more embodiments, the series of acts 800 includes receiving, via the chat window of the catalyst calendar interface, a selection of the selectable option. In addition, in one or more embodiments, the series of acts 800 includes, based on the selection, provide, for display within the integrated calendar window of the catalyst calendar interface, the event element within the collaborative time interval.

Moreover, in one or more embodiments, the series of acts 800 includes providing, for display via the chat window of the catalyst calendar interface, a selectable element comprising a suggestion for updating the calendar application to include an additional calendar event during an available time interval. Further, in one or more embodiments, the series of acts 800 includes receiving, via the chat window of the catalyst calendar interface, a selection of the selectable element. Furthermore, in one or more embodiments, the series of acts 800 includes providing, based on the selection of the selectable element and for display within the integrated calendar window of the catalyst calendar interface, additional rich calendar content comprising a representation of the additional calendar event during the available time interval.

Moreover, in one or more embodiments, the series of acts 800 includes receiving, via the chat window of the catalyst calendar interface, the event parameters comprising an indication of a priority for the calendar event. Additionally, in one or more embodiments, the series of acts 800 includes providing, for display within the integrated calendar window of the catalyst calendar interface, an indication of the priority for the calendar event within the rich calendar content. Moreover, in one or more embodiments, the series of acts 800 includes a visual indication of a priority of the calendar event, a detailed description of the calendar event, an interactive element for the calendar event, or an integration with an external model associated with the calendar event.

In addition, in one or more embodiments, the series of acts 800 includes generating, for display on a client device, a catalyst calendar interface comprising a chat window and an integrated calendar window. Additionally, in one or more embodiments, the series of acts 800 includes receiving, via the chat window of the catalyst calendar interface, an event input comprising text describing event parameters for a calendar event. Furthermore, in one or more embodiments, the series of acts 800 includes, in response to receiving the event input, generating the calendar event utilizing a large language model to process the event parameters. Moreover, in one or more embodiments, the series of acts 800 includes providing, for display within the integrated calendar window of the catalyst calendar interface, an event element comprising rich calendar content presented within an integrated view of a calendar application, wherein the rich calendar content reflects the calendar event generated by the large language model.

In addition, in one or more embodiments, the series of acts 800 includes providing, for display within the integrated calendar window, an indication of an available time interval within the calendar application. Furthermore, in one or more embodiments, the series of acts 800 includes providing, for display within the chat window, a selectable option for scheduling an additional calendar event during the available time interval.

Moreover, in one or more embodiments, the series of acts 800 includes providing, for display via the chat window of the catalyst calendar interface, a selectable option to generate an additional calendar event associated with the calendar event. Additionally, in one or more embodiments, the series of acts 800 includes receiving, via the chat window of the catalyst calendar interface, a selection of the selectable option to generate the additional calendar event. Further, in one or more embodiments, the series of acts 800 includes, in response to the selection of the selectable option, generating the additional calendar event for display within the integrated calendar window of the catalyst calendar interface utilizing the large language model.

Moreover, in one or more embodiments, the series of acts 800 includes providing, for display within the integrated calendar window of the catalyst calendar interface, a notification of a priority level associated with a scheduled calendar event. Additionally, in one or more embodiments, the series of acts 800 includes providing, via the chat window, a selectable option to generate the calendar event to replace the scheduled calendar event based on the priority level. Further, in one or more embodiments, the series of acts 800 includes providing, for display within the integrated calendar window of the catalyst calendar interface, an update to the rich calendar content visually for the event element to reflect an association between the calendar event and a target objective.

Moreover, in one or more embodiments, the series of acts 800 includes providing, for display on the client device, a set of recommended calendar events comprising an additional calendar event. In addition, in one or more embodiments, the series of acts 800 includes receiving, via the chat window of the catalyst calendar interface, a selection of the additional calendar event. Moreover, in one or more embodiments, the series of acts 800 includes providing, for display within the integrated calendar window of the catalyst calendar interface, an additional event element comprising additional rich calendar content presented within the integrated view of the calendar application, wherein the additional rich calendar content reflects the additional calendar event generated by the large language model.

In one or more implementations, each of the components of the catalyst calendar system 106 are in communication with one another using any suitable communication technologies. Additionally, the components of the catalyst calendar system 106 can be in communication with one or more other devices including one or more client devices described above. It will be recognized that in as much the catalyst calendar system 106 is shown to be separate in the above description, any of the subcomponents may be combined into fewer components, such as into a single component, or divided into more components as may serve a particular implementation.

FIG. 9 illustrates a block diagram of exemplary computing device 900 that may be configured to perform one or more of the processes described above. The components of the catalyst calendar system 106 can include software, hardware, or both. For example, the components of the catalyst calendar system 106 can include one or more instructions stored on a computer-readable storage medium and executable by processors of one or more computing devices (e.g., the exemplary computing device 900). When executed by the one or more processors, the computer-executable instructions of the catalyst calendar system 106 can cause the exemplary computing device 900 to perform the methods described herein. Alternatively, the components of the catalyst calendar system 106 can comprise hardware, such as a special purpose processing device to perform a certain function or group of functions. Additionally, or alternatively, the components of the catalyst calendar system 106 can include a combination of computer-executable instructions and hardware.

Furthermore, the components of the catalyst calendar system 106 performing the functions described herein may, for example, be implemented as part of a stand-alone application, as a model of an application, as a plug-in for applications including content management applications, as a library function or functions that may be called by other applications, and/or as a cloud-computing model. Thus, the components of the catalyst calendar system 106 may be implemented as part of a stand-alone application on a personal computing device or a mobile device.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or models and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface model (e.g., a “NIC”), and then calendar eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program models may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

As mentioned, FIG. 9 illustrates a block diagram of exemplary computing device 900 that may be configured to perform one or more of the processes described above. One will appreciate that the large language model server(s) 114, the client device(s) 124, and/or the exemplary computing device 900 may comprise one or more computing devices such as exemplary computing device 900. As shown by FIG. 9, exemplary computing device 900 can comprise processor 902, memory 904, a storage device, a I/O interface, and communication interface 910, which may be communicatively coupled by way of communication infrastructure 912. While an exemplary computing device 900 is shown in FIG. 9, the components illustrated in FIG. 9 are not intended to be limiting. Additional or alternative components may be used in other implementations. Furthermore, in certain implementations, exemplary computing device 900 can include fewer components than those shown in FIG. 9. Components of exemplary computing device 900 shown in FIG. 9 will now be described in additional detail.

In particular implementations, processor 902 includes hardware for executing instructions, such as those making up a computer program. As an example, and not by way of limitation, to execute instructions, processor 902 may retrieve (or fetch) the instructions from an internal register, an internal cache, memory 904, or storage device 906 and decode and execute them. In particular implementations, processor 902 may include one or more internal caches for data, instructions, or addresses. As an example, and not by way of limitation, processor 902 may include one or more instruction caches, one or more data caches, and one or more translation lookaside buffers (TLBs). Instructions in the instruction caches may be copies of instructions in memory 904 or storage device 906.

Memory 904 may be used for storing data, metadata, and programs for execution by the processor(s). Memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. Memory 904 may be internal or distributed memory.

Storage device 906 includes storage for storing data or instructions. As an example, and not by way of limitation, storage device 906 can comprise a non-transitory storage medium described above. Storage device 906 may include a hard disk drive (HDD), a floppy disk drive, flash memory, an optical disc, a magneto-optical disc, magnetic tape, or a Universal Serial Bus (USB) drive or a combination of two or more of these. Storage device 906 may include removable or non-removable (or fixed) media, where appropriate. Storage device 906 may be internal or external to exemplary computing device 900. In particular implementations, storage device 906 is non-volatile, solid-state memory. In other implementations, Storage device 906 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 908 allows a user to provide input to, receive output from, and otherwise transfer data to and receive data from exemplary computing device 900. I/O interface 908 may include a mouse, a keypad or a keyboard, a touch screen, a camera, an optical scanner, network interface, modem, other known I/O devices or a combination of such I/O interfaces. I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 908 is configured to provide graphical data to a display for presentation to a user. The graphical data may be representative of one or more graphical interfaces and/or any other graphical content as may serve a particular implementation.

Communication interface 910 can include hardware, software, or both. In any calendar event, communication interface 910 can provide one or more interfaces for communication (such as, for example, packet-based communication) between exemplary computing device 900 and one or more other computing devices or networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, communication interface 910 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 910 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 910 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 912 may include hardware, software, or both that couples components of exemplary computing device 900 to each other. As an example and not by way of limitation, communication infrastructure 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 10 is a schematic diagram illustrating environment 1000 within which one or more implementations of the catalyst calendar system 106 can be implemented. As discussed above with respect to FIG. 1, in some embodiments the catalyst calendar system can be part of a content management system. In such cases, the catalyst calendar system can perform various functions a content management system performs, as described below. The content management system 1002 may generate, store, manage, receive, and send digital content (such as digital videos). For example, content management system 1002 may send and receive digital content to and from the user client device 1006 by way of network 1004. In particular, the content management system 1002 can store and manage a collection of digital content. The content management system 1002 can manage the sharing of digital content between computing devices associated with a plurality of users. For instance, the content management system 1002 can facilitate a user sharing a digital content with another user of content management system 1002.

In particular, the content management system 1002 can manage synchronizing digital content across multiple of the user client device 1006 associated with one or more users. For example, a user may edit digital content using user client device 1006. The content management system 1002 can cause user client device 1006 to send the edited digital content to content management system 1002. Content management system 1002 then synchronizes the edited digital content on one or more additional computing devices.

In addition to synchronizing digital content across multiple devices, one or more implementations of content management system 1002 can provide an efficient storage option for users that have large collections of digital content. For example, content management system 1002 can store a collection of digital content on content management system 1002, while the user client device 1006 only stores reduced-sized versions of the digital content. A user can navigate and browse the reduced-sized versions (e.g., a thumbnail of a digital image) of the digital content on user client device 1006. In particular, one way in which a user can experience digital content is to browse the reduced-sized versions of the digital content on user client device 1006.

Another way in which a user can experience digital content is to select a reduced-size version of digital content to request the full- or high-resolution version of digital content from content management system 1002. In particular, upon a user selecting a reduced-sized version of digital content, user client device 1006 sends a request to content management system 1002 requesting the digital content associated with the reduced-sized version of the digital content. Content management system 1002 can respond to the request by sending the digital content to user client device 1006. User client device 1006, upon receiving the digital content, can then present the digital content to the user. In this way, a user can have access to large collections of digital content while minimizing the amount of resources used on user client device 1006.

User client device 1006 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. User client device 1006 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1004.

Network 1004 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which user client devices 1006 may access content management system 1002.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, for display on a client device, a catalyst calendar interface comprising a chat window and an integrated calendar window;
receiving, via the chat window of the catalyst calendar interface, an event input indicating event parameters for a calendar event;
in response to receiving the event input, generating the calendar event utilizing a large language model to process the event parameters; and
providing, for display within the integrated calendar window of the catalyst calendar interface, an event element comprising rich calendar content presented within an integrated view of a calendar application, wherein the rich calendar content reflects the calendar event generated by the large language model.

2. The computer-implemented method of claim 1, further comprising receiving, via the chat window of the catalyst calendar interface, the event input via a text input field for interacting with the large language model through text prompts.

3. The computer-implemented method of claim 1, further comprising:
generating, for display via the chat window of the catalyst calendar interface, a selectable option comprising a recommendation to execute an executable task associated with the calendar event;
receiving, via the chat window of the catalyst calendar interface, a selection of the selectable option; and
based on the selection, executing the executable task by communicating with one or more external models.

4. The computer-implemented method of claim 1, further comprising:
generating, for display via the chat window of the catalyst calendar interface, an indication of a target objective associated with the calendar event and a selectable option associated with modifying the calendar event based on the target objective;
receiving, via the chat window of the catalyst calendar interface, a selection of the selectable option;
generating, via the large language model, a modified calendar event from the calendar event based on the selection of the selectable option; and
providing the modified calendar event for display within the integrated calendar window of the catalyst calendar interface, the modified calendar event.

5. The computer-implemented method of claim 1, further comprising generating, via the large language model and in response to the event input, a series of calendar events comprising the calendar event and whose completion accomplishes a target objective.

6. The computer-implemented method of claim 1, further comprising providing, for display within the integrated calendar window of the catalyst calendar interface, an additional event element comprising additional rich calendar content presented within the integrated view of the calendar application, wherein the additional rich calendar content reflects an additional calendar event generated by the large language model.

7. The computer-implemented method of claim 1, further comprising:
determining, based on the event input, a target objective corresponding to the calendar event; and
wherein the event element further comprises a visual indication of a correlation between the calendar event and the target objective.

8. A system comprising:
at least one processor; and
a non-transitory computer readable medium comprising instructions that, when executed by the at least one processor, cause the system to:
generate, for display on a client device, a catalyst calendar interface comprising a chat window and an integrated calendar window;
receive, via the chat window of the catalyst calendar interface, an event input indicating event parameters for a calendar event;
cause, in response to receiving the event input, a large language model to generate the calendar event based on the event parameters; and
provide, for display within the integrated calendar window of the catalyst calendar interface, an event element comprising rich calendar content presented within an integrated view of a calendar application, wherein the rich calendar content reflects the calendar event generated by the large language model.

9. The system of claim 8, further comprising instructions that, when executed by the at least one processor, cause the system to provide, via the integrated calendar window, the event element comprising the calendar event scheduled for an event duration within an available time interval in relation to a current time.

10. The system of claim 8, further comprising instructions that, when executed by the at least one processor, cause the system to:
determine, from one or more connectors integrating data from external computer applications, background event parameters defining scheduling preferences for generating the calendar event; and
arrange, for display within the integrated calendar window of the catalyst calendar interface, the event element based on the event parameters and the background event parameters.

11. The system of claim 8, further comprising instructions that, when executed by the at least one processor, cause the system to:
determine, utilizing the large language model, a collaborative time interval for scheduling the calendar event for a first user account and a second user account;
provide, via the chat window of the catalyst calendar interface, a selectable option to schedule the calendar event within the collaborative time interval;
receive, via the chat window of the catalyst calendar interface, a selection of the selectable option; and
based on the selection, provide, for display within the integrated calendar window of the catalyst calendar interface, the event element within the collaborative time interval.

12. The system of claim 8, further comprising instructions that, when executed by the at least one processor, cause the system to:
provide, for display via the chat window of the catalyst calendar interface, a selectable element comprising a suggestion for updating the calendar application to include an additional calendar event during an available time interval;
receive, via the chat window of the catalyst calendar interface, a selection of the selectable element; and
provide, based on the selection of the selectable element and for display within the integrated calendar window of the catalyst calendar interface, additional rich calendar content comprising a representation of the additional calendar event during the available time interval.

13. The system of claim 8, further comprising instructions that, when executed by the at least one processor, cause the system to:
receive, via the chat window of the catalyst calendar interface, the event parameters comprising an indication of a priority for the calendar event; and
provide, for display within the integrated calendar window of the catalyst calendar interface, an indication of the priority for the calendar event within the rich calendar content.

14. The system of claim 8, wherein the rich calendar content comprises a visual indication of a priority of the calendar event, a detailed description of the calendar event, an interactive element for the calendar event, or an integration with an external model associated with the calendar event.

15. A non-transitory computer readable medium comprising instructions that, when executed by at least one processor, cause the at least one processor to:
generate, for display on a client device, a catalyst calendar interface comprising a chat window and an integrated calendar window;
receive, via the chat window of the catalyst calendar interface, an event input comprising text describing event parameters for a calendar event;
in response to receiving the event input, generate the calendar event utilizing a large language model to process the event parameters; and
provide, for display within the integrated calendar window of the catalyst calendar interface, an event element comprising rich calendar content presented within an integrated view of a calendar application, wherein the rich calendar content reflects the calendar event generated by the large language model.

16. The non-transitory computer readable medium of claim 15, further comprising instructions that, when executed by the at least one processor, cause the at least one processor to:
provide, for display within the integrated calendar window, an indication of an available time interval within the calendar application; and
provide, for display within the chat window, a selectable option for scheduling an additional calendar event during the available time interval.

17. The non-transitory computer readable medium of claim 15, further comprising instructions that, when executed by the at least one processor, cause the at least one processor to:
provide, for display via the chat window of the catalyst calendar interface, a selectable option to generate an additional calendar event associated with the calendar event;
receive, via the chat window of the catalyst calendar interface, a selection of the selectable option to generate the additional calendar event; and
in response to the selection of the selectable option, generate the additional calendar event for display within the integrated calendar window of the catalyst calendar interface utilizing the large language model.

18. The non-transitory computer readable medium of claim 15, further comprising instructions that, when executed by the at least one processor, cause the at least one processor to:
provide, for display within the integrated calendar window of the catalyst calendar interface, a notification of a priority level associated with a scheduled calendar event; and
provide, via the chat window, a selectable option to generate the calendar event to replace the scheduled calendar event based on the priority level.

19. The non-transitory computer readable medium of claim 15, further comprising instructions that, when executed by the at least one processor, cause the at least one processor to provide, for display within the integrated calendar window of the catalyst calendar interface, an update to the rich calendar content visually for the event element to reflect an association between the calendar event and a target objective.

20. The non-transitory computer readable medium of claim 15, further comprising instructions that, when executed by the at least one processor, cause the at least one processor to:
provide, for display on the client device, a set of recommended calendar events comprising an additional calendar event;
receive, via the chat window of the catalyst calendar interface, a selection of the additional calendar event; and
provide, for display within the integrated calendar window of the catalyst calendar interface, an additional event element comprising additional rich calendar content presented within the integrated view of the calendar application, wherein the additional rich calendar content reflects the additional calendar event generated by the large language model.
